(19) United States
(12) Patent Application Publication
(10) Pub. No.: US 2019/0258118 A1
(43) Pub. Date: Aug. 22, 2019

(54) METHOD FOR DESIGNING LIQUID CRYSTAL DISPLAY DEVICE, METHOD FOR MANUFACTURING LIQUID CRYSTAL DISPLAY DEVICE, AND LIQUID CRYSTAL DISPLAY DEVICE

(71) Applicant: SHARP KABUSHIKI KAISHA, Sakai City, Osaka (JP)

(72) Inventor: MASANOBU MIZUSAKI, Sakai City (JP)

(73) Assignee: SHARP KABUSHIKI KAISHA, Sakai City, Osaka (JP)

(21) Appl. No.: 16/333,784

(22) PCT Filed: Sep. 20, 2017
(86) PCT No.: PCT/JP2017/033891

§ 371 Date: Mar. 15, 2019

(30) Foreign Application Priority Data
Sep. 29, 2016 (JP) 2016-190893

(51) Int. Cl. G02F 1/1337; G02F 1/13363

(52) U.S. Cl. CPC G02F 1/133711; G02F 1/133788; G02F 2001/133633; G02F 2001/133746; G02F 1/13363

(57) ABSTRACT

Provided is a method for designing a liquid crystal display device including a liquid crystal layer containing a negative liquid crystal material and a pair of vertical alignment films sandwiching the liquid crystal layer. The method includes a step of determining a coefficient depending on the anchoring intensity of the liquid crystal material in the liquid crystal layer by using a material for forming the alignment film and the liquid crystal material, and a step of determining an optical compensation value necessary for the retardation occurring when the pretilt angle of the alignment film is changed in the liquid crystal display device using the material for forming the alignment film and the liquid crystal material based on the determined coefficient and the following Expressions (1) to (3):

Re(photo)=Δn×d[\sqrt{(nₑ²+nₒ²)}×cos{θ−(X−α)}−nₒ]×C (1)

Δn=|nₑ−nₒ| (2)

\sqrt{(nₑ²+nₒ²)}×cos θ=nₒ (3)

### TECHNICAL FIELD

The present invention relates to a method for designing a liquid crystal display device, a method for manufacturing a liquid crystal display device, and a liquid crystal display device.

This application claims priority to Japanese Patent Application No. 2016-190893 filed on Sep. 29, 2016, and the entire contents of which are incorporated by reference herein.

### BACKGROUND ART

Liquid crystal display devices have been widely used as displays for portable electronic devices, such as mobile phones, and for televisions and personal computers.

An electrically controlled birefringence (ECB) system is known as one alignment mode of liquid crystal display devices (for example, see PTL 1). In the liquid crystal display device of a vertical alignment ECB system, the liquid crystal molecules (liquid crystal material) are aligned perpendicular to the substrate in a voltage non-applied state, and the tilt angle of the liquid crystal material is changed by applying a voltage, and transmission and non-transmission of polarized light is controlled by using the birefringence of the liquid crystal material.

### CITATION LIST

### Patent Literature

PTL 1: Japanese Unexamined Patent Application Publication No. 2012-173600

### SUMMARY OF INVENTION

### Technical Problem

In the liquid crystal display devices such as those described in PTL 1, the angle (pretilt angle) of the liquid crystal material with respect to the substrate in a voltage non-applied state may be controlled for improving the viewing angle or enhancing the definition. However, a change in the pretilt angle of a liquid crystal material causes a change in the magnitude of retardation occurring in polarized light passing through the liquid crystal layer, leading to light leakage at the time of black display. As a result, a problem that the black display becomes bright to decrease the contrast, which is the ratio of the brightness at the time of black display to the brightness at the time of white display, tends to occur.

In order to solve such a problem, it is conceived to provide a configuration for controlling and changing the retardation of the entire liquid crystal display device to cancel the changed retardation. In such a case, it is necessary each time to determine the degree of retardation that should be controlled.

However, when the pretilt angle is controlled according to a design change for, for example, improving the response speed or enhancing the definition using a liquid crystal display device already exhibiting desired physical properties as reference, the change in the pretilt angle is slight in many cases. Accordingly, it is complicated to appropriately design the configuration of, for example, a phase difference layer that cancels the retardation occurred according to a change in the pretilt angle by appropriately evaluating a slightly occurring change in retardation and further imparting appropriate retardation, resulting in a reduction in productivity.

An aspect of the present invention has been made in view of such circumstances, and it is an object to provide a method for designing a liquid crystal display device that can easily suppress a decrease in contrast even if the pretilt angle is controlled. In addition, it is also an object to provide a method for manufacturing a liquid crystal display device that can easily suppress a reduction in contrast, by using the determined optical compensation value. In addition, it is an object to provide a liquid crystal display device that exhibits high contrast and can display high-quality images.

### Solution to Problem

In order to solve the above-mentioned problems, an embodiment of the present invention provides a method for designing a liquid crystal display device including a liquid crystal layer containing a negative liquid crystal material and a pair of vertical alignment films sandwiching the liquid crystal layer. The method includes a step of determining a coefficient depending on the anchoring intensity of the liquid crystal material in the liquid crystal layer by using a material for forming the alignment film and the liquid crystal material; and a step of determining an optical compensation value necessary for the retardation occurring when the pretilt angle of the alignment film is changed in the liquid crystal display device using the material for forming the alignment film and the liquid crystal material based on the determined coefficient and the following Expressions (1) to (3):

[Math. 1]

Re(photo)=Δn×d[\sqrt{(nₑ²+nₒ²)}×cos{θ−(X−α)}−nₒ]×C (1)

Δn=|nₑ−nₒ| (2)

\sqrt{(nₑ²+nₒ²)}×cos θ=nₒ (3)

(where, Re(photo) represents the optical compensation value; d represents the thickness of the liquid crystal layer; nₑ represents an extraordinary light refractive index of the liquid crystal material constituting the liquid crystal layer; nₒ represents an ordinary light refractive index of the liquid crystal material constituting the liquid crystal layer; θ represents the angle formed by the vector of nₒ and the composite vector of the vector of nₒ and the vector of nₑ when the liquid crystal layer is assumed as a refractive index ellipsoid; X represents the pretilt angle of the alignment film of a reference liquid crystal display device; α represents a pretilt angle changed from the pretilt angle in the reference liquid crystal display device; and C represents a coefficient depending on the anchoring intensity of the liquid crystal layer).

In an embodiment of the present invention, the α in the method may be 75° or more and less than 88.5°.

In an embodiment of the present invention, the Δn in the method may be 0.09 or more and 0.11 or less.

In an embodiment of the present invention, the d in the method may be 3.0 μm or more and 3.5 μm or less.

In an embodiment of the present invention, the Re(photo) in the method may be higher than 0 nm and 10 nm or less.

An embodiment of the present invention provides a method for manufacturing a liquid crystal display device including a pair of substrates, a negative liquid crystal layer sandwiched between the pair of substrates, a phase difference layer possessed by at least one of the pair of substrates, and a pretilt angle control layer stacked in contact with the phase difference layer and imparting a pretilt angle of 75° or more and less than 88.5° to a liquid crystal material constituting the liquid crystal layer. The method includes a step of determining an optical compensation value to be compensated by the phase difference layer through the method for designing a liquid crystal display device described above; a step of forming the phase difference layer having the determined optical compensation value; and a step of forming the pretilt angle control layer on a surface of the phase difference layer.

In an embodiment of the present invention, in the manufacturing method, the phase difference layer may be formed of a liquid crystal polymer, and the step of forming a phase difference layer may include a sub-step of applying a polymerizable liquid crystal monomer and a sub-step of rubbing the formed coating film in one direction and then polymerizing the liquid crystal monomer contained in the coating film to prepare a liquid crystal polymer.

In an embodiment of the present invention, in the manufacturing method, the phase difference layer may be formed of a mixture of a polymer material and a birefringent compound having birefringence dispersed in the polymer material, and the step of forming the phase difference layer may include a sub-step of applying a mixture of a photocurable monomer of the polymer material and the birefringent compound and a sub-step of irradiating the formed coating film with polarized light to polymerize the monomer to prepare the mixture.

An embodiment of the present invention provides a liquid crystal display device including an element substrate, an opposite substrate facing the element substrate, and a liquid crystal layer containing a negative liquid crystal material and sandwiched between the element substrate and the opposite substrate, wherein the element substrate includes a first substrate and a first alignment film of a vertical alignment type provided on the first substrate on the liquid crystal layer side to be in contact with the liquid crystal layer; the opposite substrate includes a second substrate and a second alignment film of a vertical alignment type provided on the second substrate on the liquid crystal layer side to be in contact with the liquid crystal layer; and at least one of the first alignment film and the second alignment film includes a photo-alignment type pretilt angle control layer being in contact with the liquid crystal layer and imparting a pretilt angle of 75° or more and less than 88.5° to the liquid crystal material and a phase difference layer formed by light irradiation and stacked in contact with the pretilt angle control layer.

The configuration may be that the material for forming the pretilt angle control layer is a polymer material having a photofunctional group and the material for forming the phase difference layer is a liquid crystal polymer that is a polymer of a liquid crystal monomer.

In an embodiment of the present invention, the configuration may be that the material for forming the pretilt angle control layer is a polymer material having a photofunctional group, and the material for forming the phase difference layer is a mixture of a polymer material and a birefringent compound having birefringence dispersed in the polymer material.

In an embodiment of the present invention, the configuration may be that the photofunctional group is a cinnamate group.

### Advantageous Effects of Invention

According to an aspect of the present invention, it is possible to provide a method for designing a liquid crystal display device that can easily suppress a reduction in contrast. In addition, it is possible to provide a method for manufacturing a liquid crystal display device that can easily suppress a reduction in contrast by using a determined optical compensation value. In addition, it is possible to provide a liquid crystal display device that exhibits high contrast and can display high-quality images.

### BRIEF DESCRIPTION OF DRAWINGS

FIG. 1 is a cross-sectional view schematically illustrating a liquid crystal display device of a First Embodiment.

FIG. 2 is a graph showing the results of a Reference Example.

FIG. 3 is a graph showing the results of a Reference Example.

FIG. 4 is a graph showing the results of a Reference Example.

FIG. 5 is a graph showing the results of a Reference Example.

### DESCRIPTION OF EMBODIMENTS

### First Embodiment

A method for designing a liquid crystal display device and a method for manufacturing a liquid crystal display device according to a First Embodiment of the present invention will now be described with reference to the drawings. In all the following drawings, dimensions, ratios, etc. of each component are appropriately changed in order to make the drawings easy to see.

### <Method for Designing Liquid Crystal Display Device and Method for Manufacturing Liquid Crystal Display Device>

The method for designing a liquid crystal display device of the embodiment is a method for designing a liquid crystal display device including a liquid crystal layer containing a negative liquid crystal material and a pair of vertical alignment films sandwiching the liquid crystal layer. In the liquid crystal display device of the embodiment, the degree of optical compensation necessary for changing the pretilt angle is determined based on a vertical alignment type liquid crystal display device already exhibiting a desired physical property (contrast ratio).

That is, the method for designing a liquid crystal display device of the embodiment includes a step of determining a coefficient depending on the anchoring intensity of a liquid crystal layer containing a predetermined liquid crystal material by using a predetermined material for forming an alignment film and the predetermined liquid crystal material; and a step of determining the correspondence relationship of the optical compensation value necessary for the pretilt angle of the alignment film in a liquid crystal display device using the predetermined material for forming the alignment film and the predetermined liquid crystal material based on the determined coefficient and the following Expressions (1) to (3):

[Math. 2]

Re(photo)=Δn×d[\sqrt{(nₑ²+nₒ²)}×cos{θ−(X−α)}−nₒ]×C (1)

Δn=|nₑ−nₒ| (2)

\sqrt{(nₑ²+nₒ²)}×cos θ=nₒ (3)

In Expressions, Re(photo) represents the retardation value of the phase difference layer and is preferably 0.1 nm or more and 10 nm or less.

d represents the thickness (unit: nm) of the liquid crystal layer.

nₑ represents an extraordinary light refractive index of the liquid crystal material constituting the liquid crystal layer.

nₒ represents an ordinary light refractive index of the liquid crystal material constituting the liquid crystal layer.

θ represents the angle formed by the vector of nₒ and the composite vector of the vector of nₒ and the vector of nₑ when the liquid crystal layer is assumed as a refractive index ellipsoid.

X represents the pretilt angle (unit: °) of the alignment film of an existing liquid crystal display device (reference liquid crystal display device) expressing a desired contrast ratio and is 75° or more and less than 88.5°. In the reference liquid crystal display device, when the pretilt angles imparted to the liquid crystal material by a pair of alignment films are different from each other, X represents the average of the pretilt angles by the pair of alignment films.

α represents the changed pretilt angle (unit: °) of the liquid crystal display device. In the liquid crystal display device after the change, when the pretilt angles imparted to the liquid crystal material by a pair of alignment films are different from each other, α represents the smaller pretilt angle.

C represents a coefficient depending on the (polar angle) anchoring intensity of the liquid crystal layer. A larger anchoring intensity of the liquid crystal layer tends to increase the coefficient C. Here, the alignment direction of the liquid crystal layer is set in the 45° direction with respect to the crossed-Nicol polarizer. The coefficient C is 0.01 to 0.20.

Here, the coefficient C can be determined by, for example, as follows.

First, two or more liquid crystal cells in which only the pretilt angles imparted to the photo-alignment films are different are produced using the material for forming the photo-alignment film of a reference liquid crystal display device and the material (liquid crystal material) of the liquid crystal layer of the reference liquid crystal display device. On this occasion, the azimuth angles of the pretilt angles are set to be the same as that of the reference liquid crystal display device.

Subsequently, the retardation of each of the resulting liquid crystal cells is measured.

Subsequently, a graph (scatter diagram) for the pretilt angles and the measured retardation is formed based on measured values with the horizontal axis representing the pretilt angle and the vertical axis representing the retardation value. A graph separately formed based on Expression (1) shown above is superimposed on the scatter diagram. On this occasion, the coefficient C in Expression (1) is changed to determine a coefficient C so that the measured retardation values and the graph based on Expression (1) appropriately agree with each other (fitting of Expression (1) to the measured values). Thus, the coefficient C is determined.

The coefficient C may be determined from measured values as described above or may be determined using simulation results instead of measured values. The simulation can be performed using, for example, LCD Master (manufactured by Shintech Inc.).

For example, when a liquid crystal display device of a transmitted light intensity that is equivalent to that of an existing liquid crystal display device (e.g., an existing liquid crystal display device having a pretilt angle of) 88.5° is manufactured at a pretilt angle of 87°, an appropriate retardation value, Re(photo), of the phase difference layer can be estimated by using Expression (1) shown above.

The method for manufacturing a liquid crystal display device of the embodiment is a method for manufacturing a liquid crystal display device including a pair of substrates, a negative liquid crystal layer sandwiched between the pair of substrate, a phase difference layer possessed by at least one of the pair of substrates, and a pretilt angle control layer stacked in contact with the phase difference layer and imparting a pretilt angle of 75° or more and less than 88.5° to a liquid crystal material constituting the liquid crystal layer. The method includes a step of determining an optical compensation value to be compensated by the phase difference layer through the method for designing a liquid crystal display device described above; a step of forming the phase difference layer having the determined optical compensation value; and a step of forming the pretilt angle control layer on a surface of the phase difference layer.

In the liquid crystal display device, the angle (pretilt angle) of the liquid crystal material with respect to the substrate in a voltage non-applied state may be controlled for improving the viewing angle or enhancing the definition. However, a change in the pretilt angle of a liquid crystal material causes a change in the magnitude of retardation occurring in polarized light passing through the liquid crystal layer, leading to light leakage at the time of black display. As a result, a problem that the black display becomes bright to decrease the contrast, which is the ratio of the brightness at the time of black display to the brightness at the time of white display, tends to occur.

However, in the method for designing a liquid crystal display device of the embodiment, it is possible to easily determine the retardation cancelling the change in retardation of the liquid crystal layer occurring at the time of controlling the pretilt angle. Accordingly, light leakage at the time of black display of the liquid crystal display device can be suppressed by providing the phase difference layer (the first phase difference layer or the second phase difference layer) having the retardation.

In the resulting liquid crystal display device, the phase difference to be imparted to the phase difference layer can be controlled by changing various conditions, such as the irradiation amount of polarized light in the formation of the phase difference layer, the angle of irradiation of polarized light on the phase difference layer with respect to the alignment direction of the liquid crystal, the material for forming the phase difference layer, and the thickness of the phase difference layer. Accordingly, it is possible to appropriately control the retardation value that should be possessed by the phase difference layer (the first phase difference layer or the second phase difference layer) even if the retardation caused by a change in the pretilt angle of the liquid crystal material is minute.

### <Liquid Crystal Display Device>

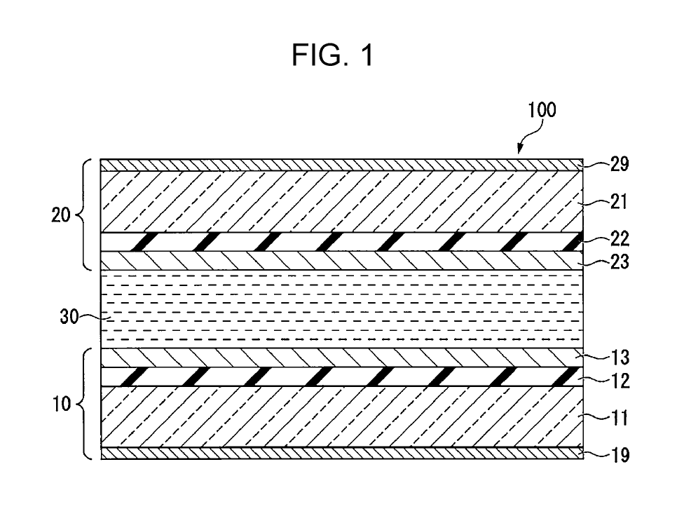

FIG. 1 is a cross-sectional view schematically illustrating the liquid crystal display device of the embodiment. As shown in FIG. 1, the liquid crystal display device 100 of the embodiment includes an element substrate 10, an opposite substrate 20, and a liquid crystal layer 30. The liquid crystal display device 100 can be manufactured by the method for designing a liquid crystal display device and the method for manufacturing a liquid crystal display device of the embodiment.

The liquid crystal display device 100 of the embodiment employs a device configuration of a vertical alignment (VA) system ECB mode. That is, the liquid crystal display device 100 is a vertical alignment type liquid crystal display device. In the present specification, the term “vertical alignment type” refers to a configuration that the pretilt angle to the liquid crystal material contained in a liquid crystal layer 30 is 75° or more when no voltage is applied to the liquid crystal layer 30.

### (Element Substrate)

The element substrate 10 includes a TFT substrate 11, a first phase difference layer 12 provided on the surface of the TFT substrate 11 on the liquid crystal layer 30 side, a first pretilt angle control layer 13 provided on the surface of the first phase difference layer 12 and being in contact with the first phase difference layer 12, and a first polarizer 19 provided on the TFT substrate 11 on the side opposite to the liquid crystal layer 30. A laminated film formed by lamination of the first phase difference layer 12 and the first pretilt angle control layer 13 corresponds to the “first alignment film” in an aspect of the present invention.

TFT substrate 11 includes a driving TFT element (not shown). The drain electrode, the gate electrode, and the source electrode of the driving TFT element are electrically connected to a pixel electrode, a gate bus line, and a source bus line, respectively. Pixels are electrically connected to each other via the electrical wiring of the source bus line and the gate bus line.

The materials for forming each member of the TFT substrate 11 can be commonly used materials. As the material of the semiconductor layer of the driving TFT is preferably IGZO (quaternary mixed crystal semiconductor material containing indium (In), gallium (Ga), zinc (Zn), and oxygen (O)). When IGZO is used as a material for forming a semiconductor layer, since the off-leakage current of the resulting semiconductor layer is small, charge leakage is suppressed. Consequently, the idle period after the application of a voltage to the liquid crystal layer can be increased. As a result, the number of times of voltage application during an image display period can be decreased, and the power consumption of the liquid crystal display device can be reduced.

The TFT substrate 11 of the liquid crystal display device may be an active matrix system in which each pixel includes a driving TFT or may be a simple matrix system in which each pixel does not include a driving TFT.

### (First Phase Difference Layer)

The first phase difference layer 12 is an optical element formed of a birefringent material to have birefringence and imparting a predetermined phase difference (retardation) to incident straight polarized light. The first phase difference layer 12 of the embodiment is provided on a surface of the TFT substrate 11. The first phase difference layer 12 is a layer formed by light irradiation. The term “formation by light irradiation” means both that the material for forming the first phase difference layer 12 is photopolymerizable and that the material for forming the first phase difference layer 12 obtains birefringence by light irradiation.

The birefringent material for forming the first phase difference layer 12 is preferably (i) a liquid crystal polymer, (ii) a mixture of a polymer material and a birefringent compound having birefringence dispersed in the polymer material, or (iii) a polymer material having a photofunctional group.

### ((i) Liquid Crystal Polymer)

The liquid crystal polymer that can be used as the birefringent material is, for example, a polymer compound formed by polymerization of the liquid crystal monomer represented by the following Formula (A).

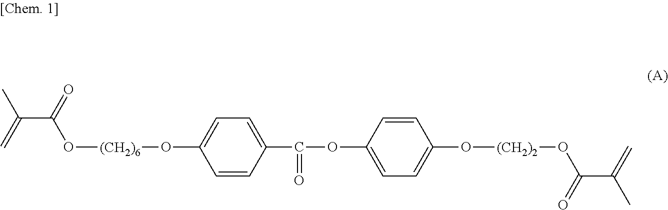

Examples of the liquid crystal polymer that can be used as the birefringent material include polymer compounds formed by polymerization of liquid crystal monomers represented by the following Formulae (A-1) to (A-14).

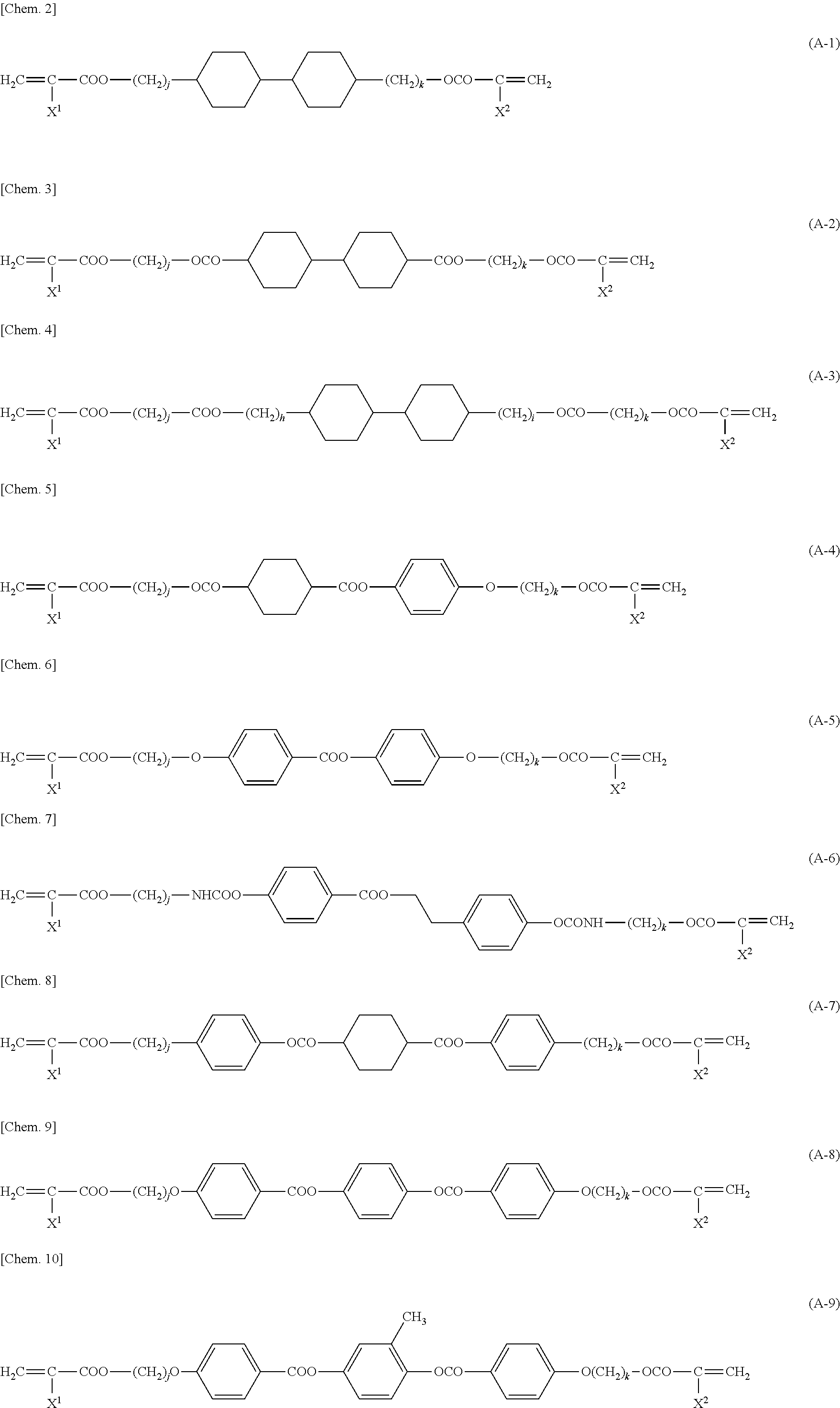

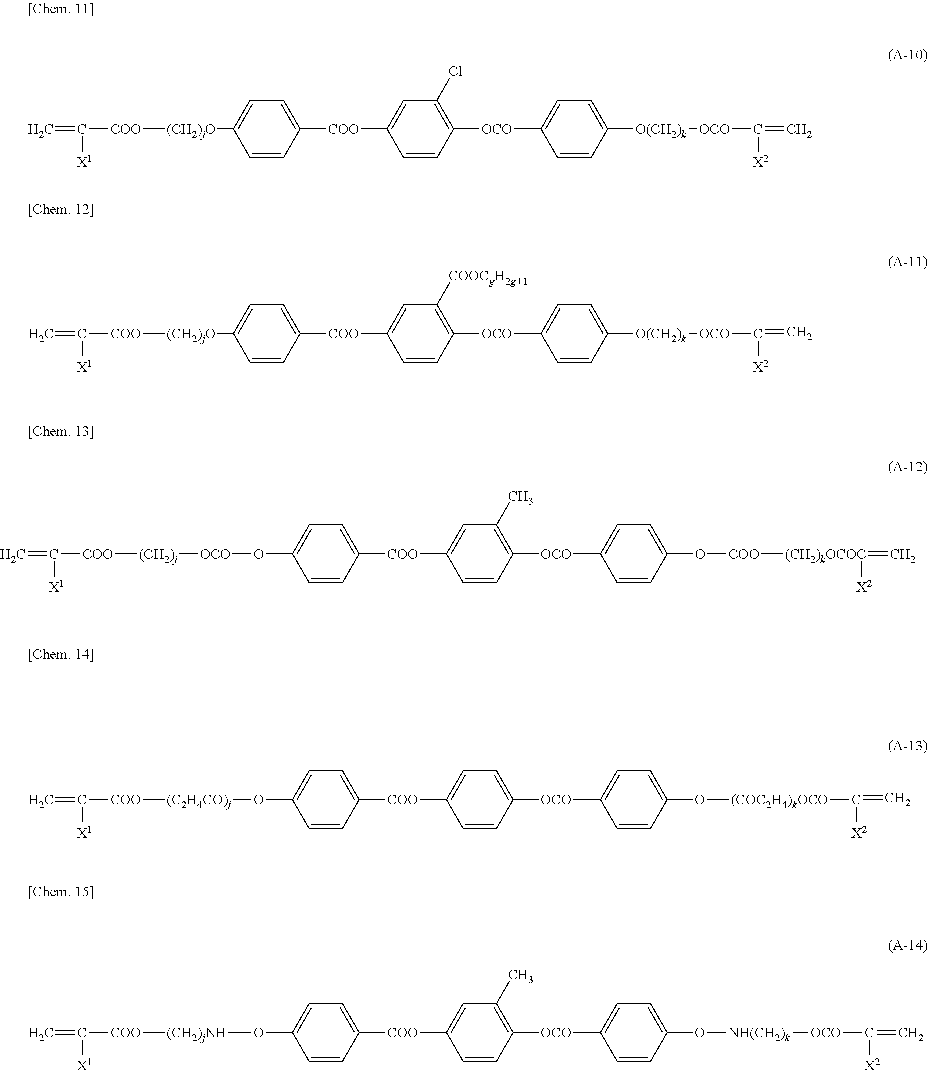

(in Formulae (A-1) to (A-14) shown above, X¹ and X² are the same or different and each represent a hydrogen atom or a methyl group; g, h, and i represent integers of 1 to 18; and j and k represent integers of 1 to 12.)

For example, the liquid crystal monomer represented by Formula (A) shown above is applied onto a substrate and is rubbed in one direction, and the coating film is then irradiated with ultraviolet light to form a first phase difference layer 12 of a liquid crystal polymer. The liquid crystal monomer is aligned in the rubbing direction, and the liquid crystal monomer is polymerized and cured while maintaining the alignment by irradiation with ultraviolet light. Consequently, a first phase difference layer 12 having birefringence can be formed. The in-plane retardation value of the first phase difference layer 12 can be controlled by the type of the liquid crystal monomer to be used and controlling the thickness of the first phase difference layer 12.

((ii) Mixture of Polymer Material and Birefringent Compound)

Examples of the polymer material that can be used in the mixture include those having optical transparency, for example, thermosetting or photocurable acrylic resins.

Examples of the birefringent compound that can be used in the mixture include a compound having an azobenzene group represented by the following Formula (B), a chalconyl compound represented by the following Formula (C), and a tolane compound represented by the following Formula (D).

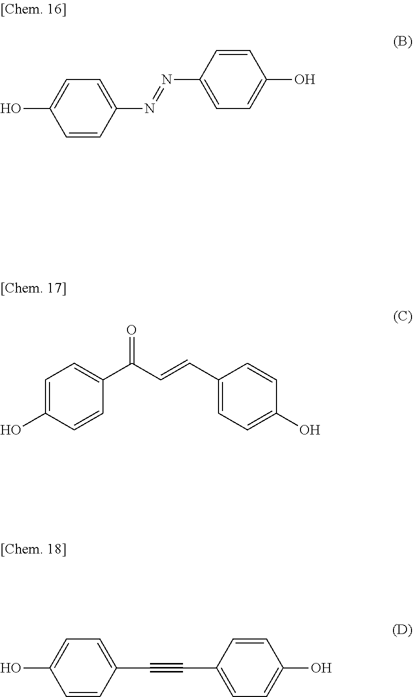 [SMILES: Oc1ccc(/N=N/c2ccc(O)cc2)cc1 ; O=C(/C=C/c1ccc(O)cc1)c1ccc(O)cc1 ; Oc1ccc(C#Cc2ccc(O)cc2)cc1]

For example, a mixture of the compound represented by Formula (B) shown above and a photocurable acrylic resin is applied onto a substrate, followed by irradiation with polarized ultraviolet light. Thus, a first phase difference layer 12 formed of the mixture can be formed. The acrylic resin is polymerized and cured by irradiation with polarized ultraviolet light. At the same time, the compound represented by Formula (B) shown above aligned in the direction in which polarized ultraviolet light can be absorbed is photoisomerized by irradiation with polarized ultraviolet light. Consequently, the polarization direction of the polarized ultraviolet light and the direction orthogonal to the polarization direction cause a phase difference, and a first phase difference layer 12 having birefringence can be formed. The in-plane retardation value of the first phase difference layer 12 can be controlled by the type of the birefringent compound to be used and controlling the thickness of the first phase difference layer 12.

((iii) Polymer Material having Photofunctional Group)

The polymer material having a photofunctional group has at least one selected from the group consisting of a polyamic acid skeleton and a (meth)acrylic skeleton as a main chain skeleton and has a photofunctional group. Hereinafter, the “polymer material having a photofunctional group”, which is a material for forming the first phase difference layer 12, is referred to as “first polymer material”.

The first photofunctional group is a group that absorbs light and causes at least one photoreaction selected from the group consisting of isomerization reaction, dimerization reaction, Fries rearrangement reaction, and cleavage reaction. The first photofunctional group is, for example, at least one group selected from the group consisting of a cinnamate group (Formula (1) shown below), an azobenzene group (Formula (2) shown below), a chalcone group (Formula (3) shown below), a tolane group (Formula (4) shown below), and a cyclobutane group (Formula (5) shown below). The first photofunctional group may be included in the main chain skeleton of the first polymer material or may be included in the side chain of the first polymer material. Since photoreaction readily occurs and the irradiation light amount for causing the photoreaction can be suppressed, the first photofunctional group is preferably included in the side chain of the first polymer material.

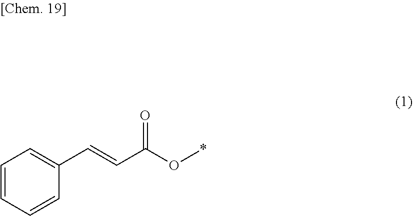 [SMILES: *OC(=O)/C=C/c1ccccc1]

(wherein, hydrogen atoms may be replaced by monovalent organic groups or fluorine atoms.)

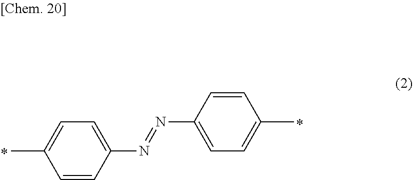

(wherein, hydrogen atoms may be replaced by monovalent organic groups.)

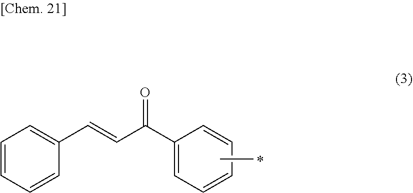

(wherein, hydrogen atoms may be replaced by monovalent organic groups.)

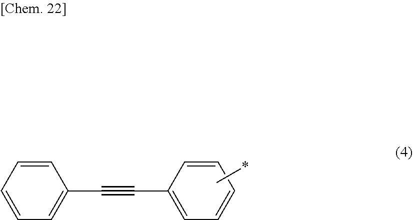

(wherein, hydrogen atoms may be replaced by monovalent organic groups.)

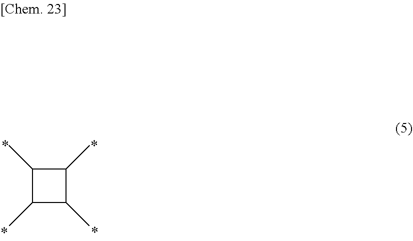

These photofunctional groups absorb light in the absorption band of each photofunctional group to cause photoisomerization, dimerization reaction, or cleavage reaction.

Specifically, examples of the first polymer material include the followings.

(Material having Polyamic Acid Skeleton)

Examples of the first polymer material having a polyamic acid skeleton include those having a polyamic acid skeleton represented by the following Formula (10) wherein the X unit included in the polyamic acid is represented by any of the following Formulae (X-1) to (X-7), the E unit is represented by any of the following Formulae (E-1) to (E-14), and either of the X unit and the E unit includes the first photofunctional group. Examples of the first photofunctional group employed in the X unit include those represented by the following Formulae (X-101) to (X-105), and examples of the first photofunctional group employed in the E unit include those represented by the following Formulae (E-101) to (E-105).

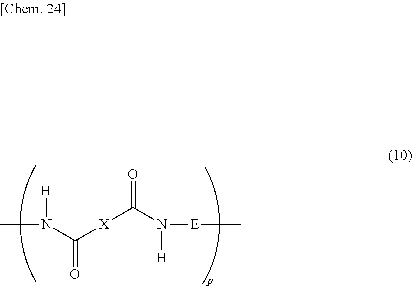

(wherein, p represents an integer.)

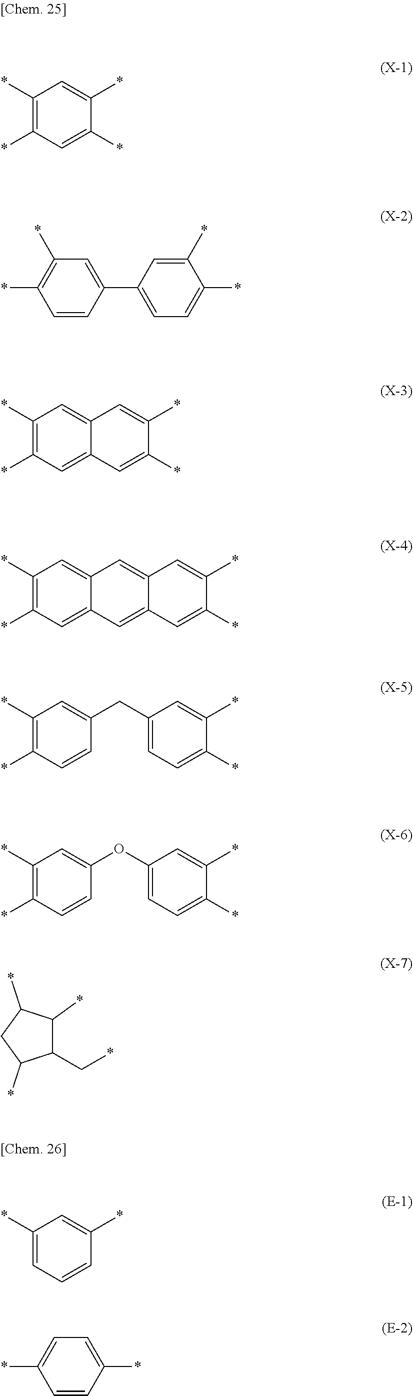

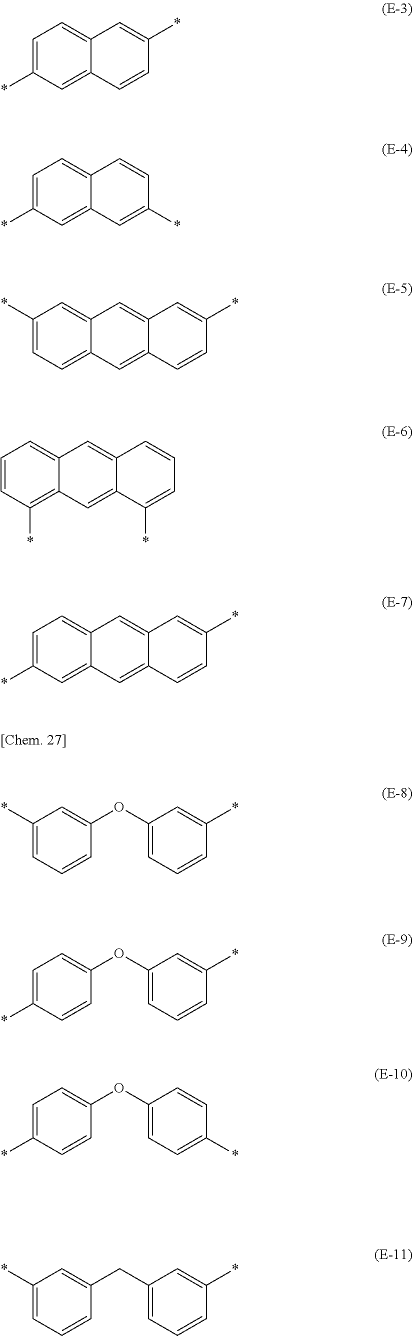

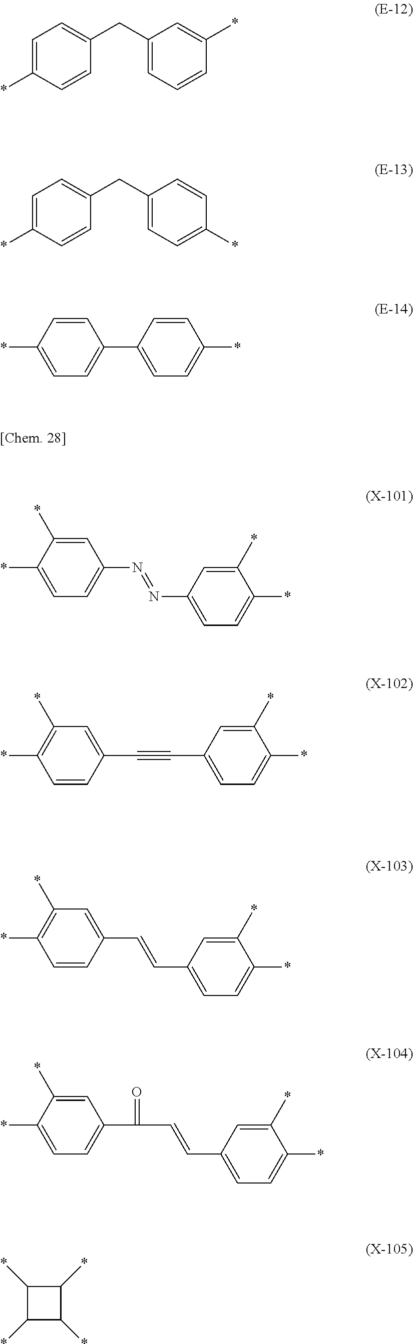

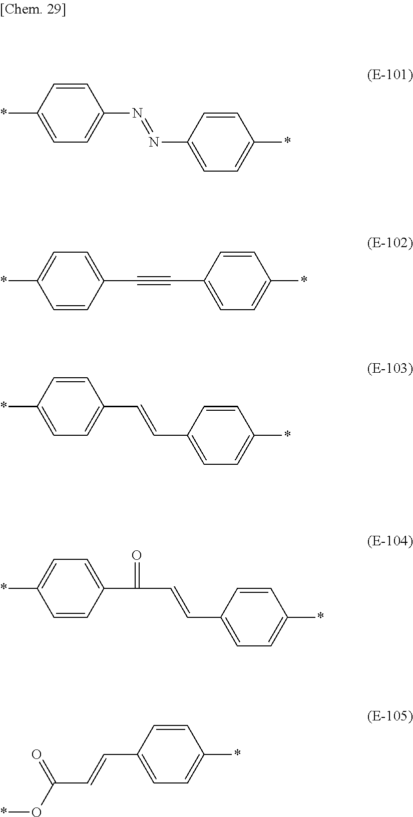 [SMILES: *c1ccc(/N=N/c2ccc(*)cc2)cc1 ; *c1ccc(C#Cc2ccc(*)cc2)cc1 ; *c1ccc(/C=C/c2ccc(*)cc2)cc1 ; *c1ccc(/C=C/C(=O)c2ccc(*)cc2)cc1 ; *OC(=O)/C=C/c1ccc(*)cc1]

In addition, examples of the first polymer material having a polyamic acid skeleton include those having a polyamic acid skeleton represented by the following Formula (11) wherein the X unit included in the polyamic acid is represented by any of Formulae (X-1) to (X-8) shown above, the E unit is represented by any of the following Formulae (E-21) to (E-36), and the Z unit includes the first photofunctional group. Examples of the first photofunctional group include those represented by the following Formulae (Z-101) to (Z-106).

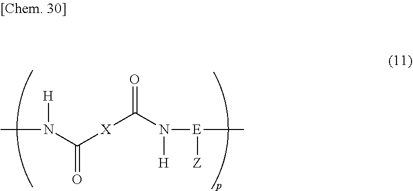

(wherein, p represents an integer.)

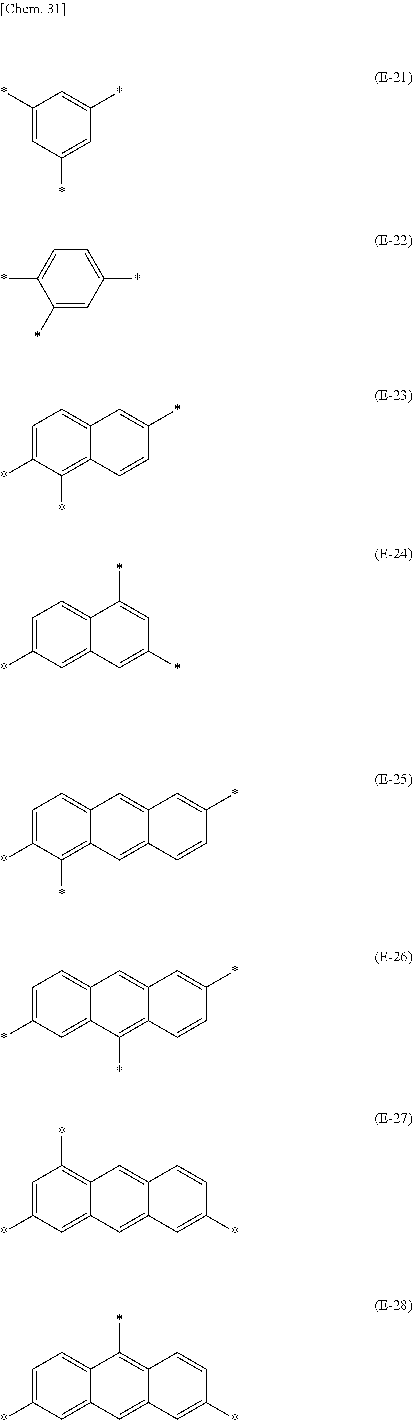

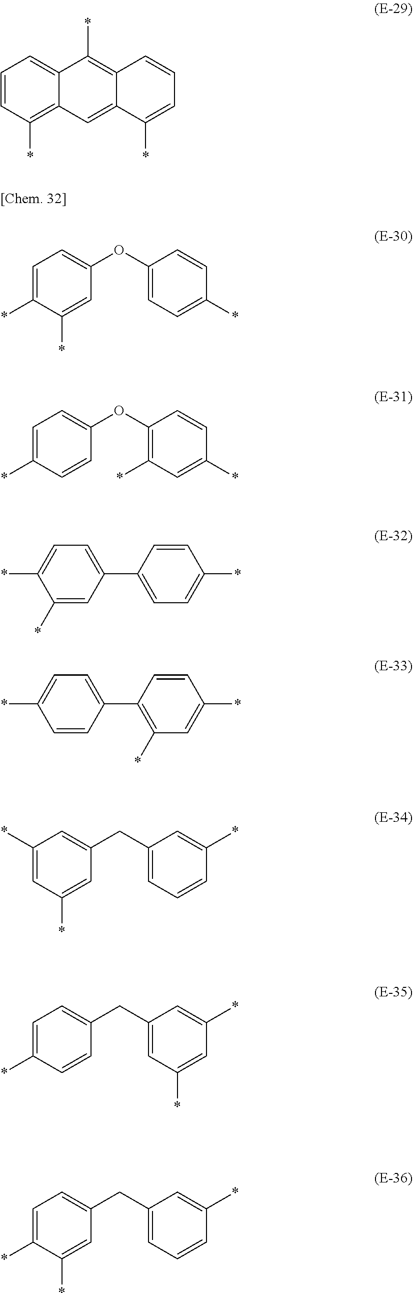

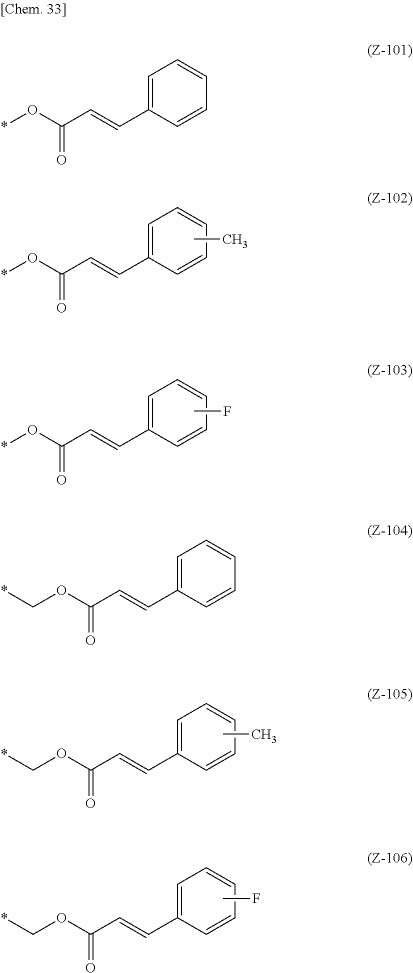

(Material having Siloxane Acid Skeleton)

Examples of the first polymer material having a siloxane acid skeleton include those having a siloxane skeleton represented by the following Formula (20) or (21) wherein the Z unit provided as a side chain includes the first photofunctional group. Examples of the first photofunctional group include those represented by Formulae (Z-101) to (Z-103) shown above.

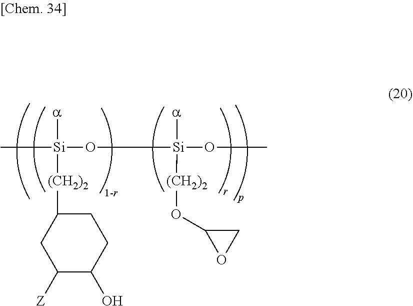

(wherein, α represents any of a hydrogen atom, a hydroxyl group, and an alkoxy group, and the multiple α's may be the same or different from each other.

r is 0<r≤0.5, and p represents an integer.)

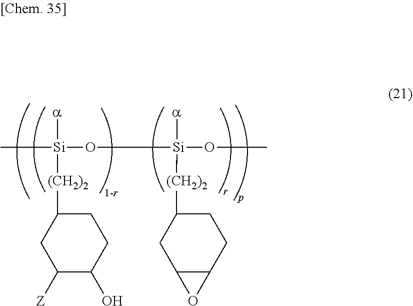

(wherein, α represents any of a hydrogen atom, a hydroxyl group, and an alkoxy group, and the multiple α's may be the same or different from each other.

r is 0<r≤0.5, and p represents an integer.)

In formation of the first phase difference layer 12, a coating film containing the material for forming the first phase difference layer 12 is first heated. Consequently, the polymer molecules constituting the coating film polymerize with each other to lose the fluidity and cure.

Subsequently, the heated coating film is irradiated with polarized light. Consequently, among the photofunctional groups as described above, the photofunctional group received the polarized light causes photoreaction. As a result, the heated coating film has anisotropy according to the polarized light direction and irradiation direction.

That is, the first phase difference layer 12 formed using the first polymer material as a formation material and being heated and irradiated with polarization light shows birefringence appropriate as a phase difference layer. The in-plane retardation value of the first phase difference layer 12 can be controlled by the type of the first polymer material to be used and controlling the thickness of the first phase difference layer 12.

### (First Pretilt Angle Control Layer)

The first pretilt angle control layer 13 has a function of imparting anchoring force to the liquid crystal material being in contact with the surface. The first pretilt angle control layer 13 may be a layer showing vertical alignment having a pretilt angle of 90° or a layer imparting a pretilt angle of 75° or more and less than 88.5° to the liquid crystal material.

As the first pretilt angle control layer 13 showing vertical alignment having a pretilt angle of 90°, a so-called vertical alignment film can be used.

As the first pretilt angle control layer 13 of a pretilt angle of 75° or more and less than 88.5°, a vertical alignment type photo-alignment film can be used. The photo-alignment film is a film formed of a material having a photofunctional group and imparted with anchoring force by light irradiation.

The material for forming the first pretilt angle control layer 13 is a polymer material having a photofunctional group. Hereinafter, the material for forming the first pretilt angle control layer 13 is referred to as “second polymer material”.

### (Second Polymer Material)

The second polymer material includes at least one skeleton selected from the group consisting of a polyamic acid skeleton and a siloxane skeleton, as the main chain skeleton. Among them, the main chain skeleton of the second polymer material is preferably a siloxane skeleton.

The second photofunctional group is a group that absorbs light and causes at least one photoreaction selected from the group consisting of isomerization reaction, dimerization reaction, and Fries rearrangement reaction. The second photofunctional group is, for example, at least one group selected from the group consisting of a cinnamate group (Formula (1) shown above), a coumarin group (Formula (5) shown below), and a stilbene group (Formula (6) shown below).

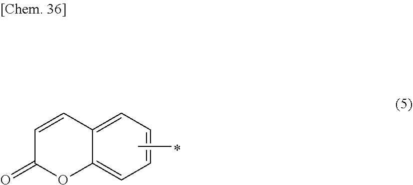

(wherein, hydrogen atoms may be replaced by monovalent organic groups.)

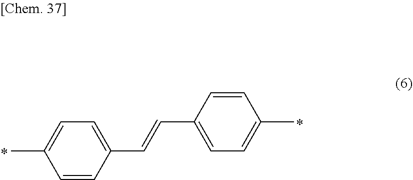

(wherein, hydrogen atoms may be replaced by monovalent organic groups.)

The second photofunctional group may be directly bonded to a silicon atom included in the above-described siloxane skeleton or may be included in the side chain bonded to the silicon atom. Since photoreaction readily occurs and the irradiation light amount for causing the photoreaction can be suppressed, the second photofunctional group is preferably included in the side chain. In addition, all the side chains are not required to include the photofunctional group, and a non-photoreactive side chain, such as a thermally crosslinking polymerizable functional group, may be included for improving the thermal and chemical stability.

These photofunctional groups absorb polarized light of the absorption band of each photofunctional group to cause photoisomerization or dimerization reaction. As a result, the second photofunctional group absorbs polarized light having a second wavelength to change the conformation, and a second pretilt angle control layer 23 defines the alignment direction of the liquid crystal material being in contact with the surface in an arbitrary direction. That is, the second pretilt angle control layer 23 can define the alignment direction of the liquid crystal material in an arbitrary direction according to the irradiation direction of the polarized light having the second wavelength at the time of formation.

Incidentally, the second photofunctional group may be the same functional group as the first photofunctional group. In addition, the second wavelength and the first wavelength may be the same.

Specifically, examples of the second polymer material include the followings.

(Material having Polyamic Acid Skeleton)

Examples of the second polymer material having a polyamic acid skeleton include those having a polyamic acid skeleton represented by Formula (11) shown above wherein the X unit included in the polyamic acid is represented by any of Formulae (X-1) to (X-8) shown above, the E unit is represented by any of Formulae (E-21) to (E-36) shown above, and the Z unit includes the second photofunctional group. Examples of the second photofunctional group include those represented by the following Formulae (Z-201) to (Z-223).

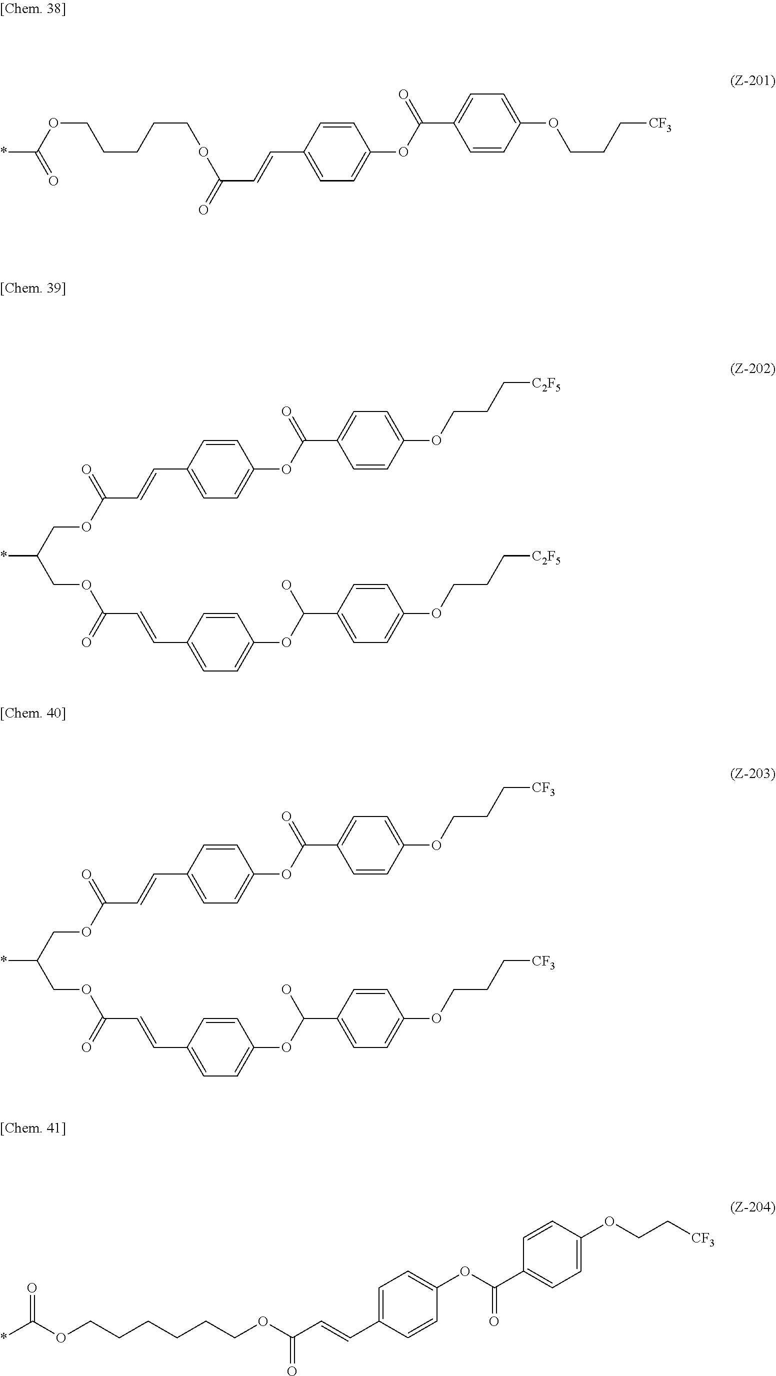

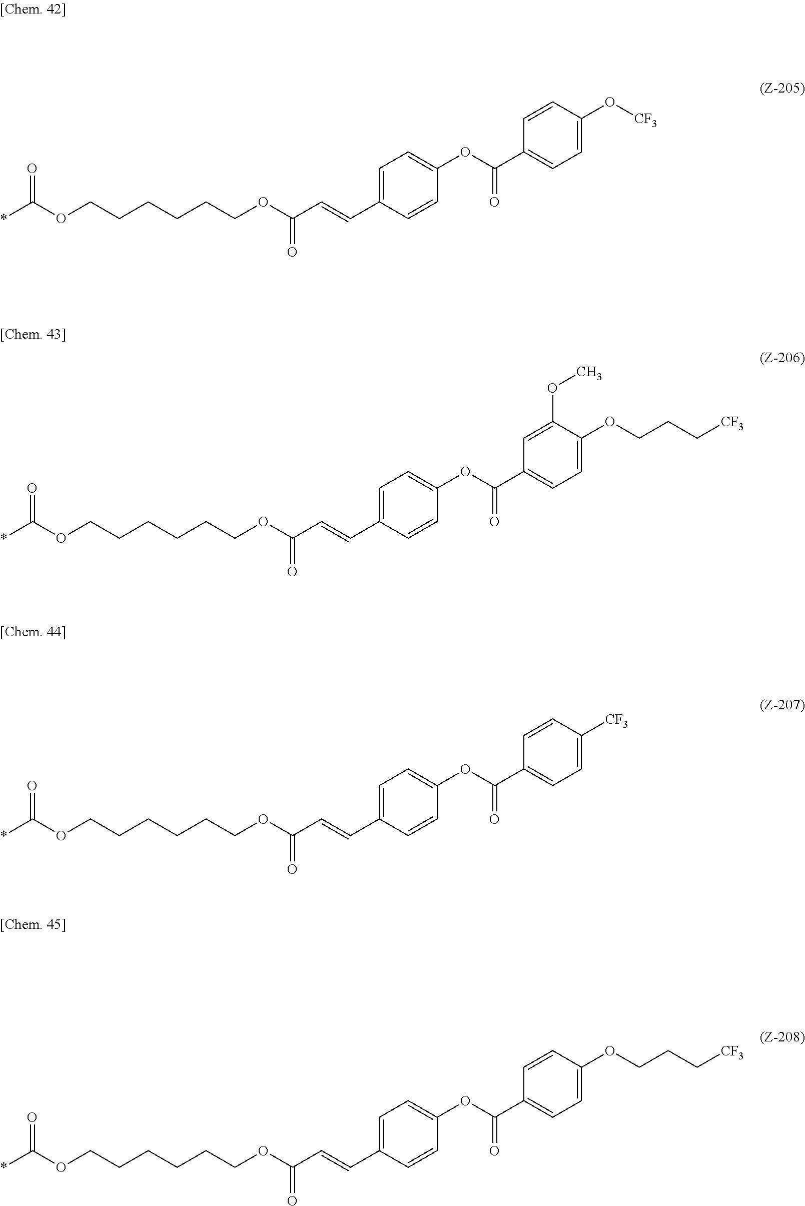 [SMILES: *C(=O)OCCCCCCOC(=O)/C=C/c1ccc(OC(=O)c2ccc(OC(F)(F)F)cc2)cc1 ; *C(=O)OCCCCCCOC(=O)/C=C/c1ccc(OC(=O)c2ccc(OCCCC(F)(F)F)c(OC)c2)cc1 ; *C(=O)OCCCCCCOC(=O)/C=C/c1ccc(OC(=O)c2ccc(C(F)(F)F)cc2)cc1 ; *C(=O)OCCCCCCOC(=O)/C=C/c1ccc(OC(=O)c2ccc(OCCCC(F)(F)F)cc2)cc1]

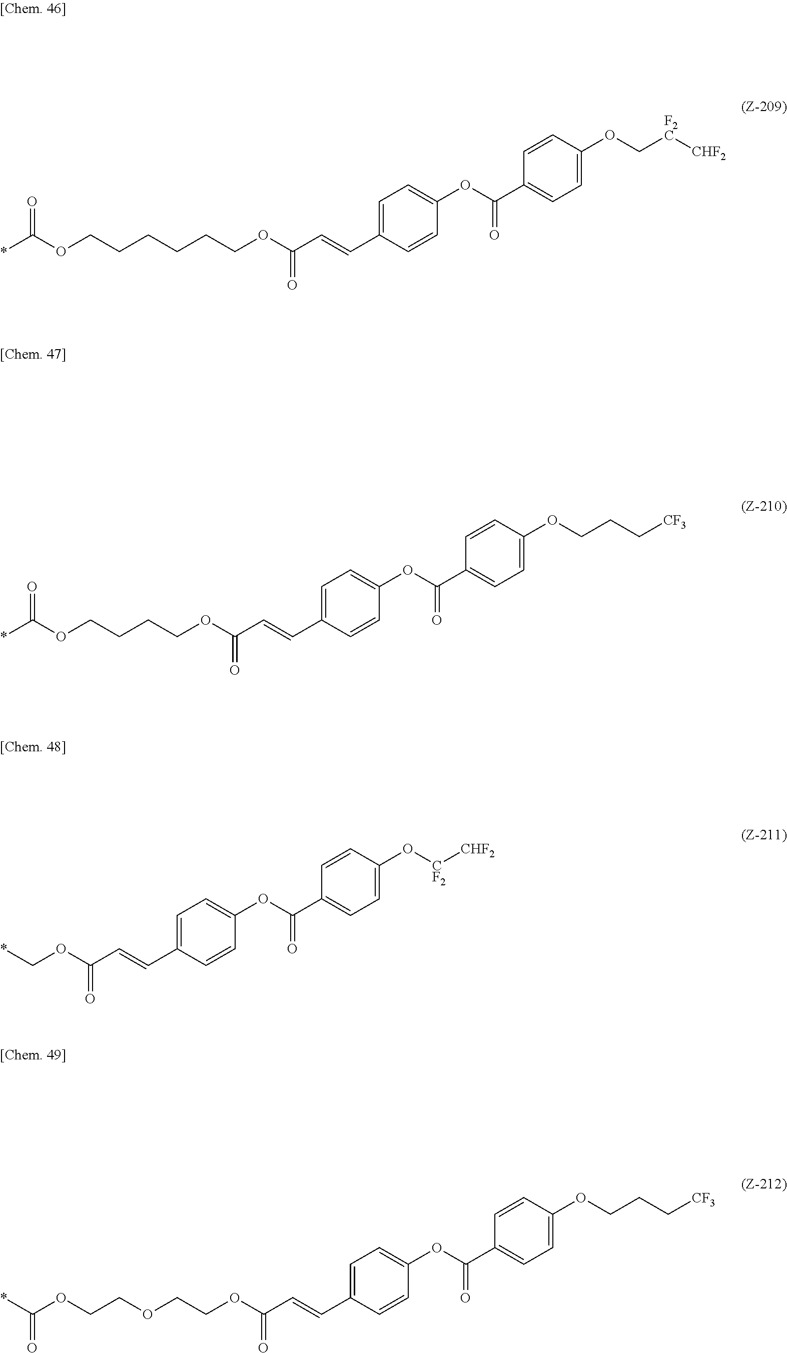 [SMILES: *C(=O)OCCCCCCOC(=O)/C=C/c1ccc(OC(=O)c2ccc(OCC(F)(F)C(F)F)cc2)cc1 ; *C(=O)OCCCCOC(=O)/C=C/c1ccc(OC(=O)c2ccc(OCCCC(F)(F)F)cc2)cc1 ; *COC(=O)/C=C/c1ccc(OC(=O)c2ccc(OC(F)(F)C(F)F)cc2)cc1 ; *C(=O)OCCOCCOC(=O)/C=C/c1ccc(OC(=O)c2ccc(OCCCC(F)(F)F)cc2)cc1]

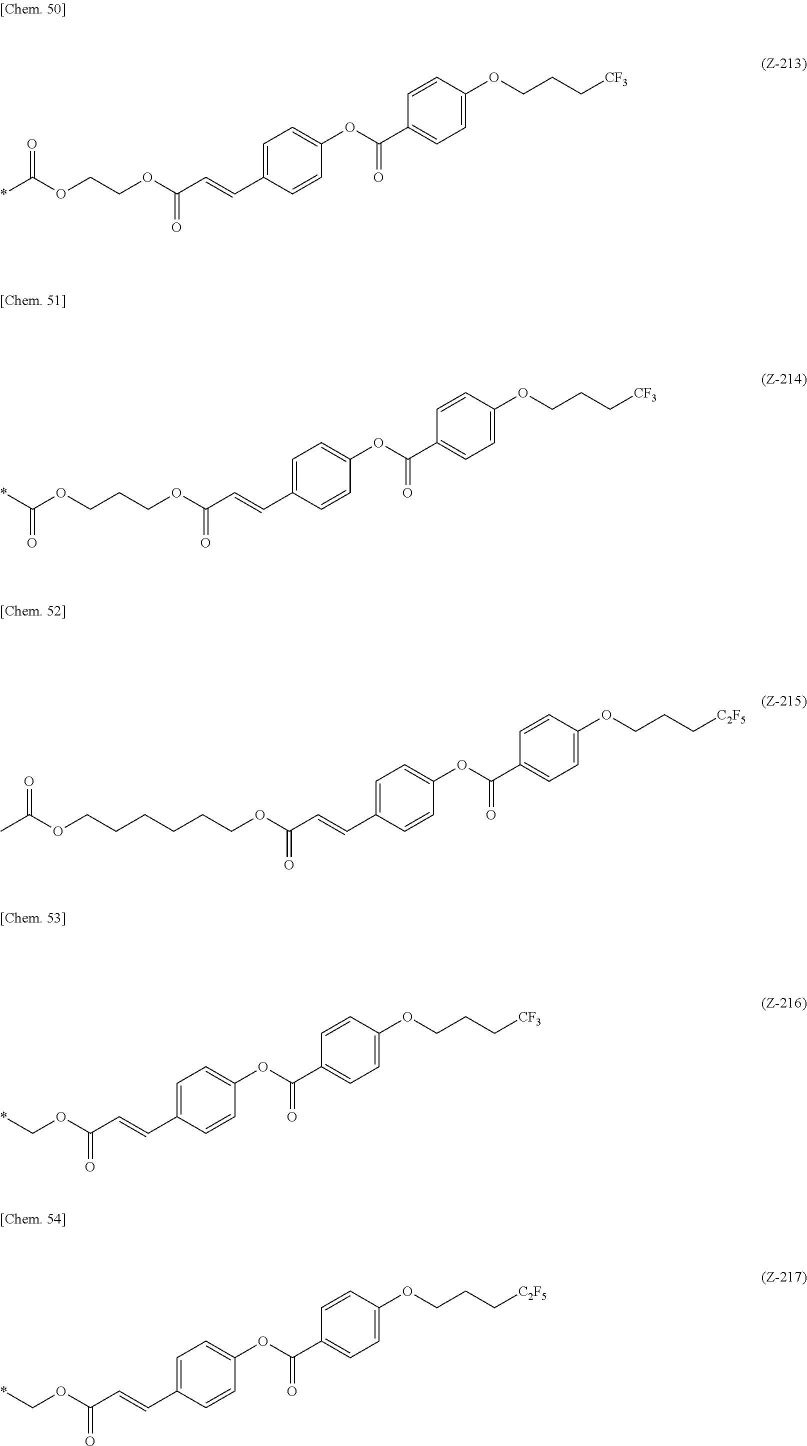

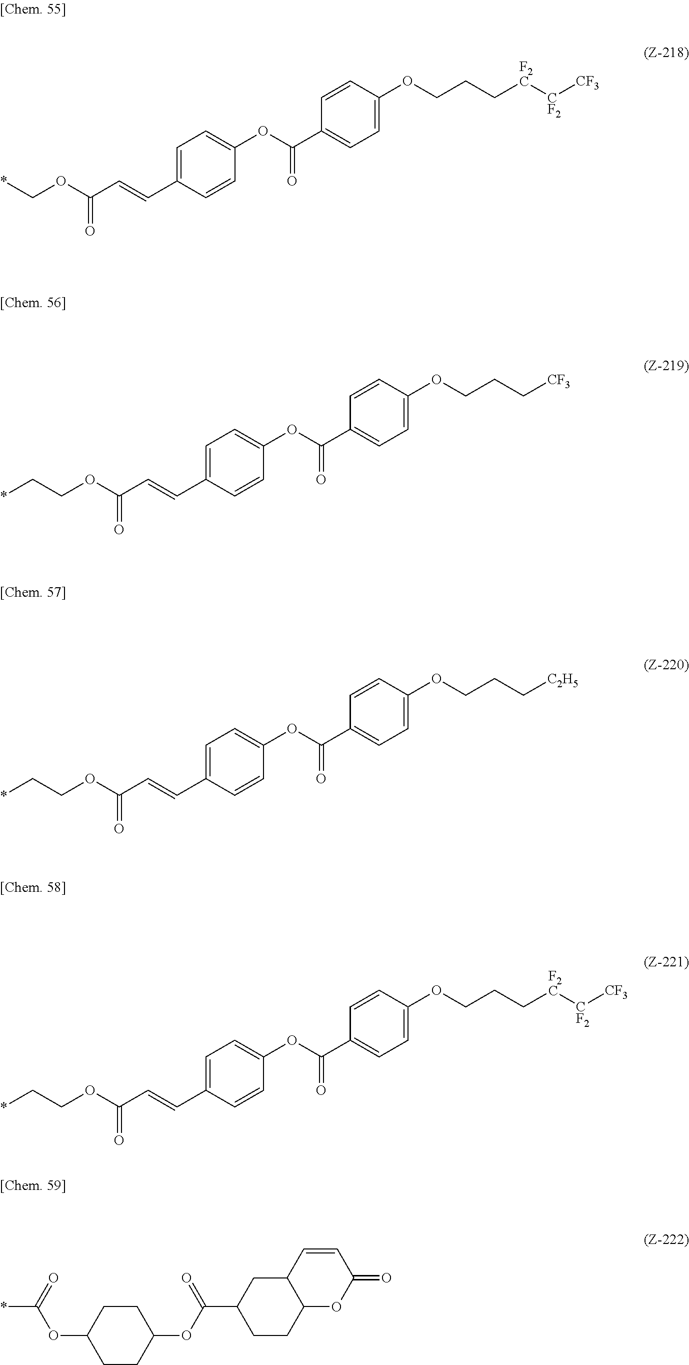 [SMILES: *COC(=O)/C=C/c1ccc(OC(=O)c2ccc(OCCCC(F)(F)C(F)(F)C(F)(F)F)cc2)cc1 ; *CCOC(=O)/C=C/c1ccc(OC(=O)c2ccc(OCCCC(F)(F)F)cc2)cc1 ; *CCOC(=O)/C=C/c1ccc(OC(=O)c2ccc(OCCCCC)cc2)cc1 ; *CCOC(=O)/C=C/c1ccc(OC(=O)c2ccc(OCCCC(F)(F)C(F)(F)C(F)(F)F)cc2)cc1 ; *C(=O)OC1CCC(OC(=O)C2CCC3OC(=O)C=CC3C2)CC1]

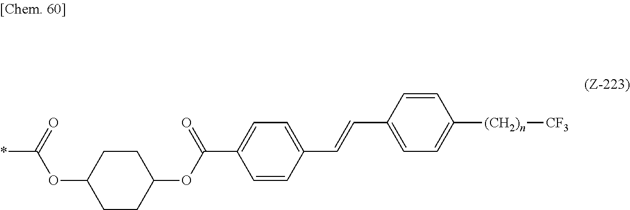

(Material having Siloxane Acid Skeleton)

Examples of the second polymer material having a siloxane acid skeleton include those having a siloxane skeleton represented by Formula (20) or (21) shown above wherein the Z unit included as a side chain includes the second photofunctional group. Examples of the second photofunctional group include those represented by the following Formulae (Z-224) and (Z-225).

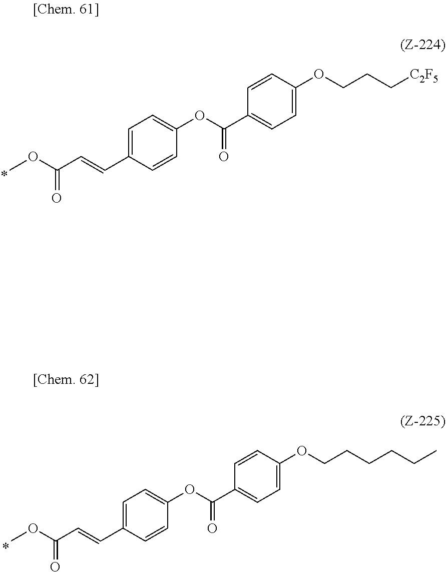

### (Material for Forming First Pretilt Angle Control Layer Showing Vertical Alignment)

When the first pretilt angle control layer 13 shows vertical alignment, specifically, examples of the formation material include the followings.

(Material having Polyamic Acid Skeleton)

In the first pretilt angle control layer 13 showing vertical alignment, examples of the formation material having a polyamic acid skeleton include those having a polyamic acid skeleton represented by Formula (11) shown above wherein the X unit included in the polyamic acid is represented by any of Formulae (X-1) to (X-8) shown above, the E unit is represented by any of Formulae (E-21) to (E-36) shown above, and the Z unit is represented by any of the following Formulae (Z-301) to (Z-307).

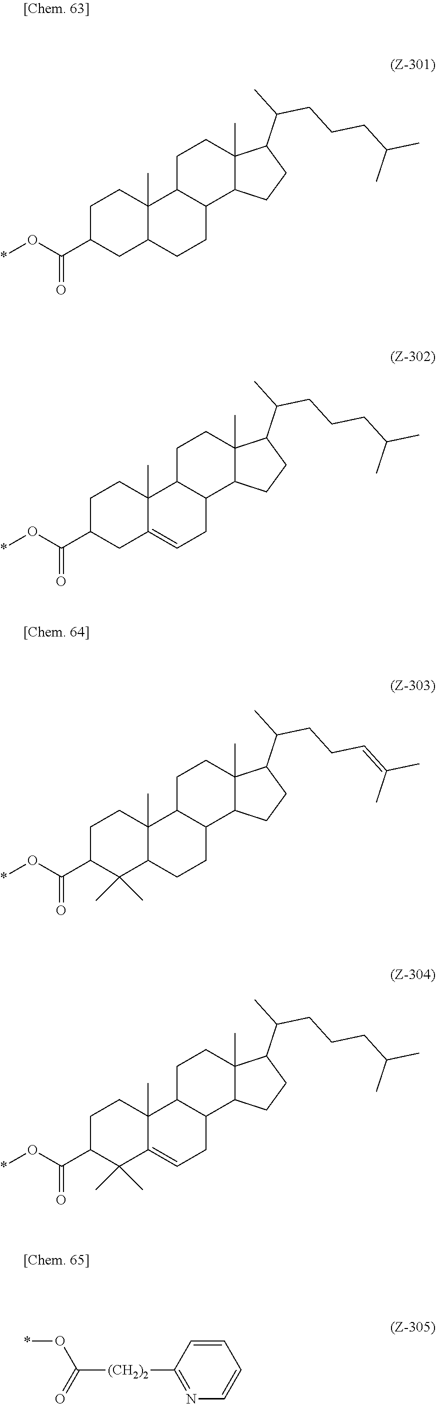

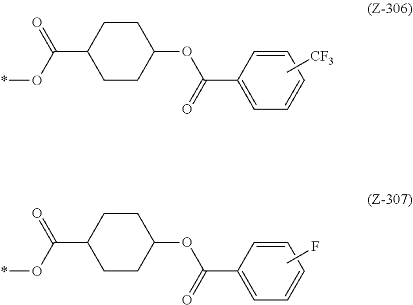

(Material having Siloxane Acid Skeleton)

Examples of the second polymer material having a siloxane acid skeleton include those having a siloxane skeleton represented by Formula (20) or (21) shown above wherein the Z unit included as a side chain is represented by any of Formulae (Z-301) to (Z-307) shown above.

In the method for manufacturing a liquid crystal display device of the embodiment, a laminated structure of the above-described first phase difference layer and first pretilt angle control layer is formed through a step of forming a phase difference layer having an optical compensation value determined by the above-described method for designing a liquid crystal display device and a step of forming a pretilt angle control layer on a surface of the phase difference layer.

When the material for forming the phase difference layer is a liquid crystal polymer, the step of forming a phase difference layer includes a sub-step of applying a polymerizable liquid crystal monomer and a sub-step of rubbing the formed coating film in one direction and then polymerizing the liquid crystal monomer contained in the coating film to prepare a liquid crystal polymer.

When the material for forming the phase difference layer is a mixture of a polymer material and a birefringent compound having birefringence dispersed in the polymer material, the step of forming a phase difference layer includes a sub-step of applying a mixture of a photocurable monomer of a polymer material and a birefringent compound and a sub-step of irradiating the formed coating film with polarized light to polymerize the monomer to prepare the mixture.

As the material for forming the phase difference layer, those described above can be used.

When a pretilt angle control layer is formed on a surface of the thus-formed phase difference layer, the material for forming the pretilt angle control layer (the above-described second polymer material) is applied and is irradiated with predetermined polarized light with an irradiation angle corresponding to a desired pretilt angle. On this occasion, the irradiation amount of polarized light is several ten mJ/cm². The irradiation amount of polarized light is preferably 10 mJ/cm² or more and 90 mJ/cm² or less and more preferably 30 mJ/cm² or more and 70 mJ/cm² or less. Consequently, a pretilt angle control layer is formed.

Liquid crystal display devices having a laminated structure of a pretilt angle control layer for horizontally aligning a liquid crystal material and a phase difference layer have been known. However, when the pretilt angle control layer for horizontal alignment is formed of a photo-alignment film, the irradiation amount of polarized light to be irradiated necessary for alignment direction control (impart of a pretilt angle) is several hundred to several thousand mJ/cm². Since irradiation of polarized light with such an irradiation amount changes the retardation of the phase difference layer formed as the lower layer, desired optical compensation cannot be achieved.

Accordingly, after accomplishment of a liquid crystal cell including a photo-alignment film, optical compensation has been performed by adhesion of a phase difference film to the outside of the cell.

On the other hand, in existing known liquid crystal display devices of a vertical alignment system, the pretilt angle of the vertical alignment film employed is 88.5° or more. The liquid crystal display device including a vertical alignment film having such a pretilt angle tends to have high contrast, and formation of a phase difference layer for improving the contrast or optical compensation by adhesion of a phase difference film is not needed.

In contrast, in liquid crystal display devices having a pretilt angle of 75° or more and less than 88.5°, the phase difference occurring in the liquid crystal layer by being imparted with a pretilt angle highly affects the contrast.

Accordingly, in such liquid crystal display devices, optical compensation is necessary for improving the contrast. However, it is difficult to cancel the phase difference slightly occurring by a change in the pretilt angle by adhesion of a phase difference film. Accordingly, the liquid crystal display device of the present application has a configuration in which the phase difference occurring in the liquid crystal layer is cancelled by the phase difference layer formed by light irradiation.

Furthermore, since the irradiation amount of polarized light necessary for alignment direction control (impart of a pretilt angle) is very low compared to the case of forming a pretilt angle control layer of horizontal alignment as described above, no disturbance occurs in the phase difference layer. Accordingly, the pretilt angle control layer can be suitably formed.

As the first polarizer 19, those having a usually known configuration can be used.

### (Opposite Substrate)

The opposite substrate 20 includes, for example, a color filter substrate 21, a second phase difference layer 22 provided on the surface of the color filter substrate 21 on the liquid crystal layer 30 side, a second pretilt angle control layer 23 provided on the surface of the second phase difference layer 22 and being in contact with the second phase difference layer 22, and a second polarizer 29 provided on the color filter substrate 21 on the side opposite to the liquid crystal layer 30. The laminated film formed by lamination of the second phase difference layer 22 and the second pretilt angle control layer 23 corresponds to the “second alignment film” in an aspect of the present invention.

The color filter substrate 21 includes, for example, a red color filter layer absorbing part of incident light and transmitting red light, a green color filter layer absorbing part of incident light and transmitting green light, and a blue color filter layer absorbing part of incident light and transmitting blue light.

Furthermore, the color filter substrate 21 may include an overcoat layer coating the surface for planarization of the substrate surface and prevention of elution of color material component from the color filter layer.

### (Second Phase Difference Layer)

The second phase difference layer 22 is an optical element formed using a birefringent material to have birefringence and imparting a predetermined phase difference (retardation) to incident straight polarized light. The second phase difference layer 22 of the embodiment is provided directly on a surface of the color filter substrate 21.

The material for forming the second phase difference layer 22 may be the same as the first polymer material described above. The retardation value of the second phase difference layer 22 may be the same as or different from that of the first phase difference layer 12. The in-plane retardation value of the second phase difference layer 22 can be controlled by the type of the material to be used and controlling the thickness of the second phase difference layer 22.

### (Second Pretilt Angle Control Layer)

The second pretilt angle control layer 23 has a function of imparting anchoring force to the liquid crystal material being in contact with the surface. The second pretilt angle control layer 23 may be a layer showing vertical alignment of a pretilt angle of 90° or may be a layer imparting a pretilt angle of 75° or more and less than 88.5° to the liquid crystal material.

As the second pretilt angle control layer 23 showing vertical alignment of a pretilt angle of 90°, a so-called vertical alignment film can be used.

As the second pretilt angle control layer 23 of a pretilt angle of 75° or more and less than 88.5°, a vertical alignment type photo-alignment film can be used.

However, one of the first pretilt angle control layer 13 and the second pretilt angle control layer 23 is a vertical alignment type photo-alignment film imparting a pretilt angle of 75° or more and less than 88.5° to the liquid crystal material. When the first pretilt angle control layer 13 is a photo-alignment film or when the second pretilt angle control layer 23 is a vertical alignment type photo-alignment film, the pretilt angle imparted to the liquid crystal material by these films is 75° or more and less than 88.5°, preferably 80.0° or more and less than 88.5°, and more preferably 80.0° or more and 88.0° or less. When the pretilt angle is such an angle, the response speed of the liquid crystal molecules is fast, and the liquid crystal display device can display high-quality images.

When both the first pretilt angle control layer 13 and the second pretilt angle control layer 23 are photo-alignment films, the pretilt angle imparted to the liquid crystal material by the first pretilt angle control layer 13 and the pretilt angle imparted to the liquid crystal material by the second pretilt angle control layer 23 may be the same or different.

When both the first pretilt angle control layer 13 and the second pretilt angle control layer 23 are vertical alignment type photo-alignment films, the alignment direction of the liquid crystal material by the first pretilt angle control layer 13 and the alignment direction of liquid crystal material by the second pretilt angle control layer 23 are preferably set to antiparallel alignment in the field of view from the normal direction of the TFT substrate 11 (the field of view when the TFT substrate is planarly viewed).

The term “antiparallel alignment” refers to that the azimuth angles of the liquid crystal materials are the same in the field of view when the TFT substrate is planarly viewed.

The material for forming the second pretilt angle control layer 23 may be the same as the second polymer material described above.

As the second polarizer 29, those having a usually known configuration can be used. The first polarizer 19 and the second polarizer 29 are disposed, for example, in a crossed-Nicol arrangement.

### (Liquid Crystal Layer)

The liquid crystal layer 30 contains a liquid crystal material having a refractive index anisotropy of 0.09 or more and 0.11 or less. The liquid crystal material is a composition including liquid crystal molecules having liquid crystallinity. The liquid crystal material may be composed of only liquid crystal molecules solely expressing liquid crystallinity or may be a composition that is a mixture of liquid crystal molecules solely expressing liquid crystallinity and an organic compound not solely expressing liquid crystallinity and expresses liquid crystallinity as a whole composition. The liquid crystal material used is negative liquid crystal of which the dielectric anisotropy is negative.

The liquid crystal molecules are imparted with orientation according to the anchoring force of the first pretilt angle control layer 13 or the second pretilt angle control layer 23 in a voltage non-applied state.

The liquid crystal layer 30 has a thickness of 3.0 μm or more and 3.5 μm or less.

Additionally, the liquid crystal display device 100 may include a sealing portion sandwiched between the element substrate 10 and the opposite substrate 20 and surrounding the circumference of the liquid crystal layer 30 and a spacer that is a columnar structure for defining the thickness of the liquid crystal layer 30.

In such a liquid crystal display device 100, the total value of the in-plane retardation value of the first phase difference layer 12 and the in-plane retardation value of the second phase difference layer 22 is within a range of higher than 0 nm and 10 nm or less. Within such a range of the in-plane retardation value, the total value of the in-plane retardation values of the first phase difference layer 12 and the second phase difference layer 22 is set by the method for designing a liquid crystal display device of the embodiment described above.

In the embodiment, although the second phase difference layer 22 is employed, a polymer layer (hereinafter referred to as underlayer) having no in-plane phase difference may be used instead of the second phase difference layer 22. As the material for forming the underlayer, a polymer material having the same main chain skeleton as that of the first polymer material or the second polymer material described above and having no photofunctional group can be used. In addition, as the material for forming the underlayer, the material for forming the vertical alignment film described above can also be employed.

Specifically, examples of the material for forming the underlayer include the followings.

Examples of the material having a polyamic acid skeleton for the underlayer include those having a polyamic acid skeleton represented by Formula (11) shown above wherein the X unit included in the polyamic acid is represented by any of Formulae (X-1) to (X-8) shown above, the E unit is represented by any of Formulae (E-21) to (E-36) shown above, and the Z unit is represented by any of the following Formulae (Z-401) to (Z-408).

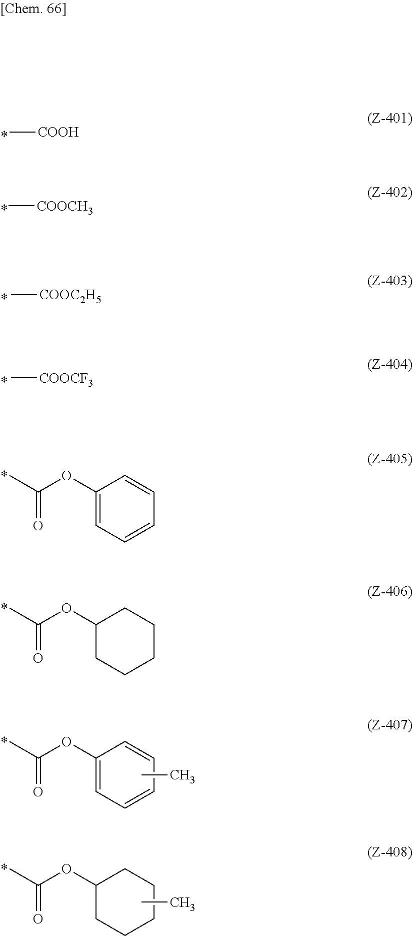

Additionally, as the material for forming the underlayer, the material having a polyamic acid skeleton for forming the vertical alignment film or the material having a siloxane skeleton for forming the vertical alignment film described above can also be used.

The liquid crystal display device of the embodiment has the above-described configuration.

According to the method for designing a liquid crystal display device having the above-described configuration, a designing method that can easily suppress a reduction in contrast can be provided.

In addition, according to the method for manufacturing a liquid crystal display device having the above-described configuration, a manufacturing method that can easily suppress a reduction in contrast can be provided by using the determined optical compensation value.

In addition, according to the liquid crystal display device having the above-described configuration, a liquid crystal display device that exhibits high contrast and can display high-quality images can be provided.

In the embodiment, although it is described that a configuration in which the first pretilt angle control layer 13 included in the element substrate 10 is a photo-alignment film and the second pretilt angle control layer 23 included in the opposite substrate 20 is a vertical alignment film can be employed, the first pretilt angle control layer 13 may be a vertical alignment film and the second pretilt angle control layer 23 may be a photo-alignment film.

Preferred embodiments according to an aspect of the present invention have been described with reference to the attached drawings, but it should be noted that the present invention is not limited to such examples. The shapes, combinations, etc. of each component shown in the above-described examples are merely examples, and various modifications can be made based on, for example, design requirements without departing from the gist of the present invention.

### EXAMPLES

An aspect of the present invention will now be described by examples, but the present invention is not limited these examples.

### <Regarding Step of Determining Coefficient C>

### Reference Example 1

Regarding the optical compensation value necessary for realizing a contrast ratio equivalent to that of a liquid crystal cell as a reference when the conditions of the reference liquid crystal cell are as follows and the pretilt angle is changed, the optical compensation value determined based on the following Expressions (1) to (3) and the optical compensation value determined by simulation were compared.

### (Reference Liquid Crystal Cell)

Liquid crystal material: nₑ=1.582, nₒ=1.485

Cell thickness: 3.40 μm

Phase difference (Δn·d) of liquid crystal cell: 330 nm

Pretilt angle: 88.5° in both of a pair of alignment films

In the following description, the optical compensation value determined based on Expressions (1) to (3) is referred to as “optical compensation value A”, and the optical compensation value determined by simulation is referred to as “optical compensation value B”. The optical compensation value A was fitted to the optical compensation value B while changing the coefficient C, and the coefficient C was determined such that the difference between the optical compensation value A and the optical compensation value B became smaller at the pretilt angle at which the optical compensation value B was determined.

[Math. 3]

Re(photo)=Δn×d[\sqrt{(nₑ²+nₒ²)}×cos{θ−(X−α)}−nₒ]×C (1)

Δn=|nₑ−nₒ| (2)

\sqrt{(nₑ²+nₒ²)}×cos θ=nₒ (3)

(where, Re(photo) represents the optical compensation value;

d represents the thickness of a liquid crystal layer and is 3.40 μm;

nₑ represents an extraordinary light refractive index of the liquid crystal material constituting the liquid crystal layer and is 1.582;

nₒ represents an ordinary light refractive index of the liquid crystal material constituting the liquid crystal layer and is 1.485;

θ represents the angle formed by the vector of nₒ and the composite vector of the vector of nₒ and the vector of nₑ when the liquid crystal layer is assumed as a refractive index ellipsoid and is 52.0°;

X represents the pretilt angle of the photo-alignment film of the reference liquid crystal display device and is 88.5°;

α represents a pretilt angle changed from the pretilt angle in the reference liquid crystal display device; and

C represents a coefficient depending on the anchoring intensity of the liquid crystal layer.)

The phase difference of the liquid crystal cell is 330 nm.

### (Simulation Conditions)

The optical compensation value was determined using LCD Master (manufactured by Shintech Inc.).

Liquid crystal material: nₑ=1.582, nₒ=1.485;

Cell thickness (liquid crystal layer thickness): 3.40 μm;

Phase difference of liquid crystal cell: 330 nm; and

Alignment film pretilt angle: 88.5°, 88.0°, 87.0°, and 86.0°.

### (Cell Configuration)

The configuration of each of a pair of substrates sandwiching the liquid crystal layer was that an underlayer was formed on the substrate and an alignment film was formed on the surface of the underlayer.

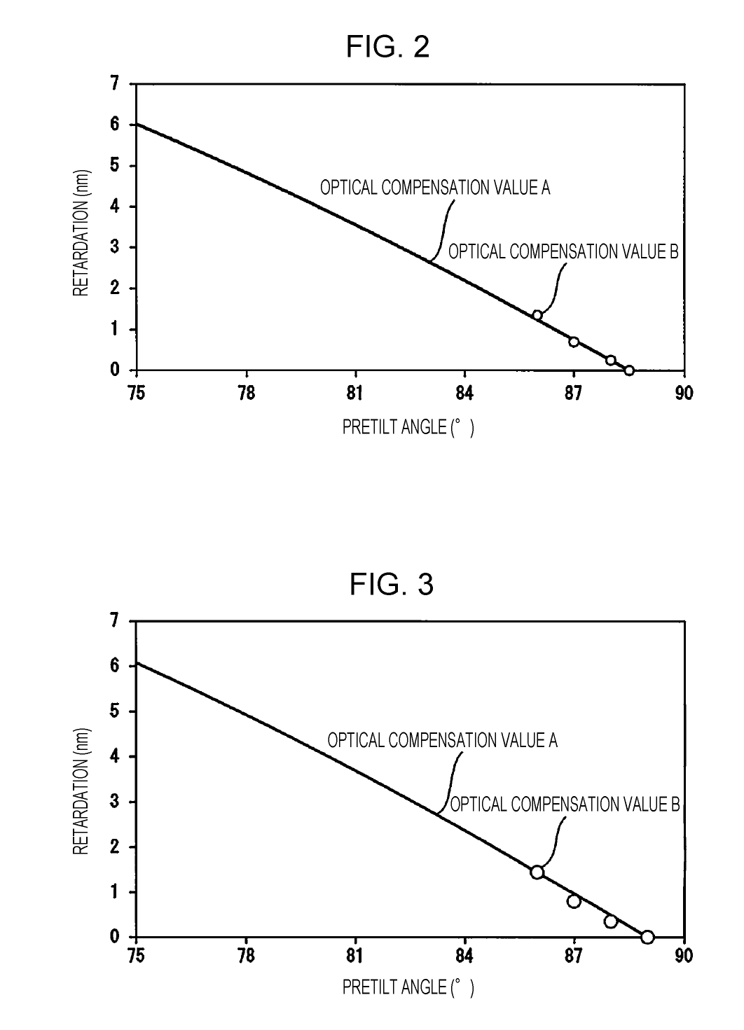

FIG. 2 is a graph comparing the optical compensation value A and the optical compensation value B. In the graph, the horizontal axis represents the pretilt angle (unit: °) and the vertical axis represents the optical compensation value (unit: nm). The coefficient C was 0.056. As shown in the graph, the optical compensation value A and the optical compensation value B well agreed with each other.

### Reference Example 2

The coefficient C was determined by comparing the optical compensation value A and the optical compensation value B as in Reference Example 1 except that the pretilt angles of the reference liquid crystal cell were 89.0° in both the pair of alignment films.

FIG. 3 is a graph comparing the optical compensation value A and the optical compensation value B. The coefficient C was 0.054. As shown in the graph, the optical compensation value A and the optical compensation value B well agreed with each other.

### Reference Example 3

The coefficient C was determined by comparing the optical compensation value A and the optical compensation value B as in Reference Example 1 except that the pretilt angles of the reference liquid crystal cell were 90° in one of the alignment films and 86.0° in the other alignment film and that in the calculation of the optical compensation values A and B, the pretilt angle in the other alignment film was changed to 84.0°, 82.0°, and 80.0°.

In Expression (1), the pretilt angle X was the average of the pretilt angle in one of the alignment films and the pretilt angle in the other alignment film. For example, in the reference liquid crystal cell, 88.0° was employed.

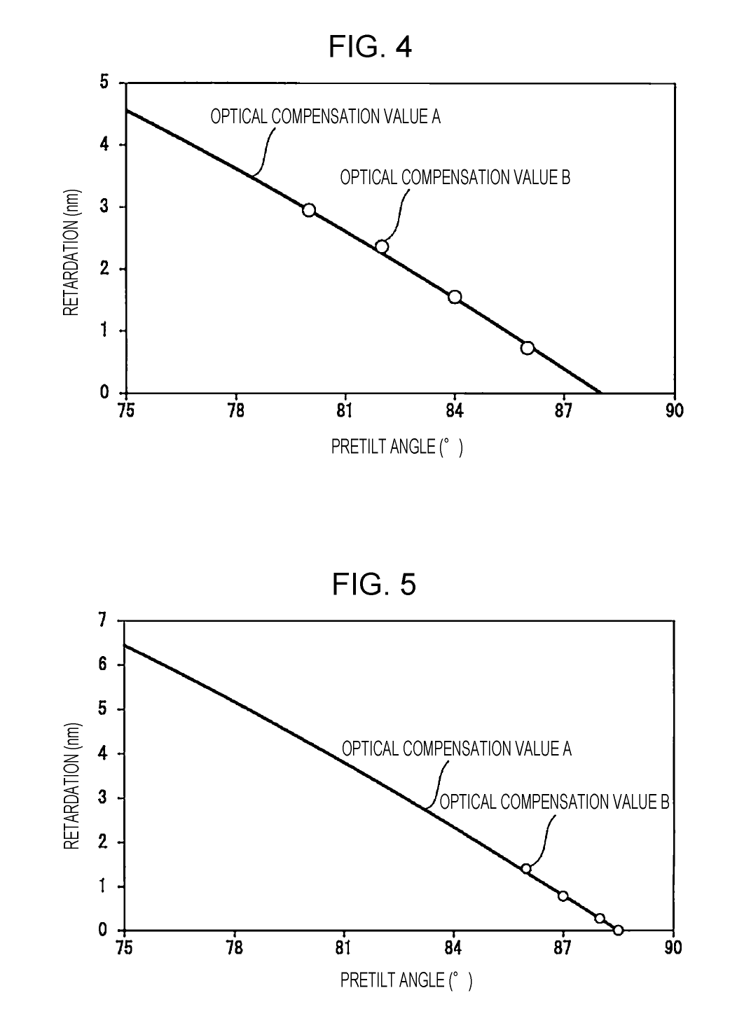

FIG. 4 is a graph comparing the optical compensation value A and the optical compensation value B. The coefficient C was 0.043. As shown in the graph, the optical compensation value A and the optical compensation value B well agreed with each other.

### Reference Example 4

The coefficient C was determined by comparing the optical compensation value A and the optical compensation value B as in Reference Example 1 except that the reference liquid crystal cell satisfying the following conditions was used.

### (Reference Liquid Crystal Cell)

Liquid crystal material: nₑ=1.591, nₒ=1.485

Cell thickness: 3.11 μm

Phase difference (Δn·d) of liquid crystal cell: 330 nm

Pretilt angle: 88.5° in both of a pair of alignment films

FIG. 5 is a graph comparing the optical compensation value A and the optical compensation value B. The coefficient C was 0.059. As shown in the graph, the optical compensation value A and the optical compensation value B well agreed with each other.

### <Physical Properties of Produced Liquid Crystal Cell>

The physical properties of the liquid crystal cells produced as described below using the method for manufacturing a liquid crystal display device of an aspect of the present invention were evaluated by the following methods.

### (Contrast)

Contrast was measured in a darkroom with SR-UL1 luminance meter manufactured by Topcon Corporation.

Measurement temperature: 25° C., Measurement wavelength range: 380 to 780 nm

### (Response Characteristics)

Measurement was performed with Photal 5200 (Otsuka Electronics Co., Ltd.).

Measurement temperature: 25° C., Measurement: between voltages of a transmittance of 0.5 to the maximum transmittance

VHR (voltage holding ratio): The VHR was measured with a VHR measurement system mode 6254 manufactured by TOYO Corporation under conditions of 1 V and 70° C. Here, VHR means the retention rate of the charge charged during one frame period. A liquid crystal display device having a higher VHR is judged to be a good quality product.

Residual DC: The residual DC was measured by a flicker erasing method. The residual DC (rDC) after application of a DC offset voltage of 2 V (AC voltage of 3 V (60 Hz)) for 2 hours was measured. A liquid crystal display device having a lower rDC is judged to be a good quality product.

Change amount of pretilt angle: The change amount between the pretilt angle before energization and the pretilt angle after energization with an AC voltage of 7.5 V was measured. A liquid crystal display device showing a less change amount in the pretilt angle is judged to be a good quality product.

### <Evaluation 1>

### Example 1

Regarding a liquid crystal display device having the configuration shown in Reference Example 1, a liquid crystal cell for evaluation was produced, and the physical properties were actually evaluated to verify the effects of the present invention. Here, the influence on contrast when the pretilt angle was changed to 87.0° from the reference liquid crystal cell (pretilt angle: 88.5°) in Reference Example 1 was verified.

A liquid crystal monomer represented by the following Formula (A) was applied to one surface of a substrate including an ITO electrode (hereinafter, referred to as substrate A) and was, after rubbing, irradiated with ultraviolet light to form a phase difference layer having an in-plane retardation of 0.7±0.2 nm. The “±0.2 nm” indicates the measurement error of the in-plane retardation.

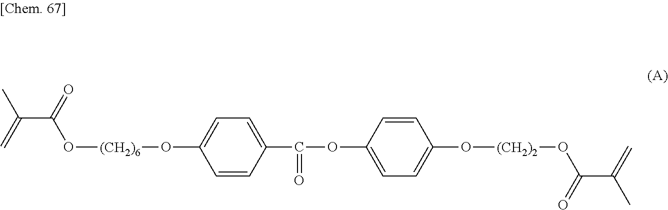

Subsequently, a paint containing a polyamic acid represented by the following Formula (101) was applied to the surface of the phase difference layer of the substrate A to form a film. The polyamic acid represented by the following Formula (101) used had a weight average molecular weight of 10000 or more.

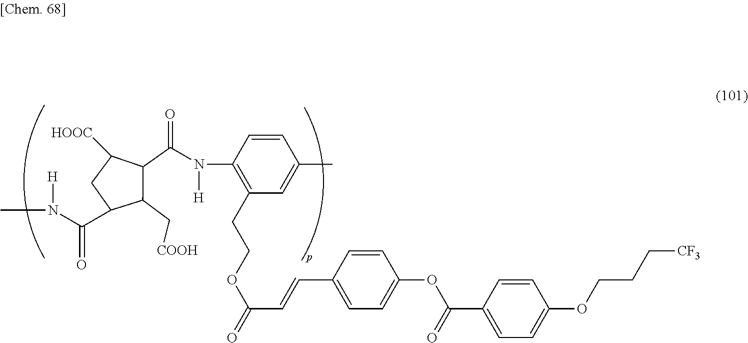

(wherein, p represents an integer.)

Subsequently, firing was performed to form a polyimide layer formed of the material represented by Formula (101) shown above.

Subsequently, 50 mJ/cm² of polarized light with a central wavelength of 315 nm was irradiated from the direction of 45° with respect to the normal direction of the substrate. Consequently, the polyimide layer formed of a material represented by Formula (101) shown above was imparted with a pretilt angle of about 87.0° to form a photo-alignment film.

Furthermore, a paint containing the polyamic acid represented by Formula (101) shown above was applied to one surface of another substrate (hereinafter, referred to as substrate B) to form a film.

Subsequently, firing was performed to form a polyimide layer formed of the material represented by Formula (101).

Subsequently, 50 mJ/cm² of polarized light with a central wavelength of 315 nm was irradiated from the direction of 45° with respect to the normal direction of the substrate to impart a pretilt angle of about 87.0° to the polyimide layer formed of the material represented by Formula (101) to form a photo-alignment film.

Subsequently, a sealing agent was drawn on one of the substrates on the photo-alignment film side, and a negative liquid crystal material was dropwise applied to the other substrate on the photo-alignment film side. In the negative liquid crystal material used, nₑ was 1.582 and nₒ was 1.485.

Both the substrates were adhered to each other under vacuum, and the sealing agent was cured, followed by heating to 130° C. for reorientation to give a liquid crystal cell. On this occasion, the cell thickness (the thickness of the liquid crystal layer) was adjusted to 3.4 μm so that the phase difference Δn·d of the liquid crystal layer was designed to be about 330 nm.

Subsequently, polarizers were adhered to each other in a crossed-Nicol arrangement to produce a liquid crystal panel of Example 1.

### Comparative Example 1

A liquid crystal cell of Comparative Example 1 was produced as in Example 1 except that no phase difference layer was formed in the substrate A. In also the liquid crystal cell of Comparative Example 1, the pretilt angle of the photo-alignment film was 87.0°.

### Reference Example A

A liquid crystal cell of Reference Example A was produced as in Comparative Example 1 except that the pretilt angle in the substrate A was 88.5°. That is, the liquid crystal cell of Reference Example A corresponds to the reference liquid crystal cell of Reference Example 1.

The resulting liquid crystal cells of Example 1, Comparative Example 1, and Reference Example A were evaluated by the above-described method. Table 1 shows the evaluation results.

TABLE 1

| | | Response time | | | | Change amount |
|---|---|---|---|---|---|---|
| | | (ms) | | VHR | rDC | in tilt angle |
| | Contrast | Rise | Decay | (%) | (mV) | (°) |
| Example 1 | 4900 | 4.4 | 3.7 | 99.5 | 70 | 0.02 |
| Comparative | 4150 | 4.3 | 3.8 | 99.5 | 70 | 0.02 |
| Example 1 | | | | | | |
| Reference | 5050 | 8.5 | 4.5 | 99.5 | 70 | 0.02 |
| Example A | | | | | | |

The results of evaluation revealed that the contrast of the liquid crystal cell of Example 1 was improved compared to the liquid crystal cell of Comparative Example 1, although there were no large differences in the response time, the VHR, the rDC, and the change amount in the tilt angle.

In addition, it was revealed that the response time of the liquid crystal cell of Example 1 was improved and the contrast was equivalent compared to the liquid crystal cell of Reference Example A.

### <Evaluation 2>

### Example 2

Regarding a liquid crystal display device having the configuration shown in Reference Example 4, a liquid crystal cell for evaluation was produced, and the physical properties were actually evaluated to verify the effects of the present invention. Here, the influence on contrast when the pretilt angle was changed to 87.0° from the reference liquid crystal cell (pretilt angle: 88.5°) in Reference Example 4 was verified.

A photocurable acrylic resin including a birefringent compound represented by the following Formula (B) was applied to one surface of a substrate A and was irradiated with polarized ultraviolet light to form a phase difference layer having an in-plane retardation of 0.8±0.2 nm. The “±0.2 nm” indicates the measurement error of the in-plane retardation.

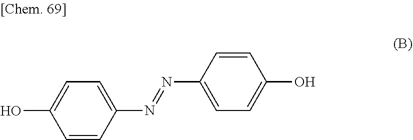 [SMILES: Oc1ccc(/N=N/c2ccc(O)cc2)cc1]

Subsequently, a paint including the polyamic acid represented by Formula (101) shown above was applied to the surface of the phase difference layer of the substrate A to form a film.

Subsequently, firing was performed to form a polyimide layer formed of the material represented by Formula (101).

Subsequently, 50 mJ/cm² of polarized light with a central wavelength of 315 nm was irradiated from the direction of 45° with respect to the normal direction of the substrate. Consequently, the polyimide layer formed of a material represented by Formula (101) shown above was imparted with a pretilt angle of about 87.0° to form a photo-alignment film.

A photo-alignment film was formed for the substrate B as in Example 1.

Subsequently, a sealing agent was drawn on one of the substrates on the photo-alignment film side, and a negative liquid crystal material was dropwise applied to the other substrate on the photo-alignment film side. In the negative liquid crystal material used, nₑ was 1.591 and nₒ was 1.485.

Both the substrates were adhered to each other under vacuum, and the sealing agent was cured, followed by heating to 130° C. for reorientation to give a liquid crystal cell. On this occasion, the cell thickness (the thickness of the liquid crystal layer) was adjusted to 3.1 μm so that the phase difference Δn·d of the liquid crystal layer was designed to be about 330 nm.

Subsequently, polarizers were adhered to each other in a crossed-Nicol arrangement to produce a liquid crystal panel of Example 2.

### Comparative Example 2

A liquid crystal cell of Comparative Example 2 was produced as in Example 2 except that no phase difference layer was formed in the substrate A. In also the liquid crystal cell of Comparative Example 2, the pretilt angle of the photo-alignment film was 87.0°.

### Reference Example B

A liquid crystal cell of Reference Example B was produced as in Comparative Example 2 except that the pretilt angle in the substrate A was 88.5°. That is, the liquid crystal cell of Reference Example B corresponds to the reference liquid crystal cell of Reference Example 4.

The resulting liquid crystal cells of Example 2, Comparative Example 1, and Reference Example B were evaluated by the above-described method. Table 2 shows the evaluation results.

TABLE 2

| | | Response time | | | | Change amount |
|---|---|---|---|---|---|---|
| | | (ms) | | VHR | rDC | in tilt angle |
| | Contrast | Rise | Decay | (%) | (mV) | (°) |
| Example 2 | 4970 | 4.3 | 3.4 | 99.5 | 40 | 0.03 |
| Comparative | 4250 | 4.3 | 3.4 | 99.5 | 40 | 0.03 |
| Example 2 | | | | | | |
| Reference | 5070 | 8.2 | 4.4 | 99.5 | 50 | 0.03 |
| Example B | | | | | | |

The results of evaluation revealed that the contrast of the liquid crystal cell of Example 2 was improved compared to the liquid crystal cell of Comparative Example 2, although there were no large differences in the response time, the VHR, the rDC, and the change amount in the tilt angle.

In addition, it was revealed that the response time of the liquid crystal cell of Example 2 was improved and the contrast was equivalent compared to the liquid crystal cell of Reference Example B.

The results described above confirmed that an aspect of the present invention is useful.

### INDUSTRIAL APPLICABILITY

An aspect of the present invention can be applied to, for example, a liquid crystal panel having a novel configuration, a method for manufacturing a liquid crystal panel that can easily manufacture such a liquid crystal panel, and a display device using them.

### REFERENCE SIGNS LIST

10 element substrate

11 TFT substrate (first substrate)

12, 14 first phase difference layer

13 first pretilt angle control layer

20 opposite substrate

21 color filter substrate (second substrate)

22, 24 second phase difference layer

23 second pretilt angle control layer

30 liquid crystal layer

100, 150 liquid crystal display device

1. A method for designing a liquid crystal display device including a liquid crystal layer containing a negative liquid crystal material and a pair of vertical alignment films sandwiching the liquid crystal layer, the method comprising:
determining a coefficient depending on anchoring intensity of the liquid crystal material in the liquid crystal layer by using a material for forming the alignment film and the liquid crystal material; and
determining an optical compensation value necessary for retardation occurring when the pretilt angle of the alignment film is changed in a liquid crystal display device using the material for forming the alignment film and the liquid crystal material based on the determined coefficient and the following Expressions (1) to (3):
[Math. 1]
Re(photo)=Δn×d[\sqrt{(nₑ²+nₒ²)}×cos{θ−(X−α)}−nₒ]×C (1)
Δn=|nₑ−nₒ| (2)
\sqrt{(nₑ²+nₒ²)}×cos θ=nₒ (3)
(where, Re(photo) represents the optical compensation value;
d represents the thickness of the liquid crystal layer;
nₑ represents an extraordinary light refractive index of the liquid crystal material constituting the liquid crystal layer;
nₒ represents an ordinary light refractive index of the liquid crystal material constituting the liquid crystal layer;
θ represents the angle formed by the vector of nₒ and the composite vector of the vector of nₒ and the vector of nₑ when the liquid crystal layer is assumed as a refractive index ellipsoid;
X represents the pretilt angle of the alignment film of a reference liquid crystal display device;
α represents a pretilt angle changed from the pretilt angle in the reference liquid crystal display device; and
C represents a coefficient depending on the anchoring intensity of the liquid crystal layer).

2. The method for designing a liquid crystal display device according to claim 1, wherein the α is 75° or more and less than 88.5°.

3. The method for designing a liquid crystal display device according to claim 1, wherein the Δn is 0.09 or more and 0.11 or less.

4. The method for designing a liquid crystal display device according to claim 1, wherein the d is 3.0 μm or more and 3.5 μm or less.

5. The method for designing a liquid crystal display device according to claim 1, wherein the Re(photo) is higher than 0 nm and 10 nm or less.

6. A method for manufacturing a liquid crystal display device including:
a pair of substrates;
a negative liquid crystal layer sandwiched between the pair of substrates;
a phase difference layer possessed by at least one of the pair of substrates; and
a pretilt angle control layer stacked in contact with the phase difference layer and imparting a pretilt angle of 75° or more and less than 88.5° to a liquid crystal material constituting the liquid crystal layer, the method comprising:
determining an optical compensation value to be compensated by the phase difference layer through the method for designing a liquid crystal display device according to claim 1;
forming the phase difference layer having the determined optical compensation value; and
forming the pretilt angle control layer on a surface of the phase difference layer.

7. The method for manufacturing a liquid crystal display device according to claim 6, wherein
the phase difference layer is formed of a liquid crystal polymer;
the step of forming the phase difference layer comprises:
applying a polymerizable liquid crystal monomer; and
rubbing a formed coating film in one direction and then polymerizing the liquid crystal monomer contained in the coating film to prepare the liquid crystal polymer.

8. The method for manufacturing a liquid crystal display device according to claim 6, wherein
the phase difference layer is formed of a mixture of a polymer material and a birefringent compound having birefringence dispersed in the polymer material;
the step of forming the phase difference layer comprises:
applying a mixture of a photocurable monomer of the polymer material and the birefringent compound; and
irradiating a formed coating film with polarized light to polymerize the monomer to prepare the phase difference layer.

9. A liquid crystal display device comprising:
an element substrate;
an opposite substrate facing the element substrate; and
a liquid crystal layer containing a negative liquid crystal material and sandwiched between the element substrate and the opposite substrate, wherein
the element substrate includes a first substrate and
a first alignment film of a vertical alignment type provided on the first substrate on the liquid crystal layer side to be in contact with the liquid crystal layer;
the opposite substrate includes a second substrate and
a second alignment film of a vertical alignment type provided on the second substrate on the liquid crystal layer side to be in contact with the liquid crystal layer; and
at least one of the first alignment film and the second alignment film includes a photo-alignment type pretilt angle control layer being in contact with the liquid crystal layer and imparting a pretilt angle of 75° or more and less than 88.5° to the liquid crystal material and
a phase difference layer formed by light irradiation and stacked in contact with the pretilt angle control layer.

10. The liquid crystal display device according to claim 9, wherein
the pretilt angle control layer is formed of a polymer material having a photofunctional group; and
the phase difference layer is formed of a liquid crystal polymer that is a polymer of a liquid crystal monomer.

11. The liquid crystal display device according to claim 9, wherein
the pretilt angle control layer is formed of a polymer material having a photofunctional group; and
the phase difference layer is formed of a mixture of a polymer material and a birefringent compound having birefringence dispersed in the polymer material.

12. The liquid crystal display device according to claim 10, wherein the photofunctional group is a cinnamate group.
